(19) United States
(12) Patent Application Publication
(10) Pub. No.: US 2026/0211694 A1
(43) Pub. Date: Jul. 23, 2026

(54) SYSTEM AND METHOD FOR A MOTION-RESPONSIVE RECONFIGURING OF A NON-VOLATILE RECONFIGURABLE METASURFACE

(71) Applicant: Dell Products LP, Round Rock, TX (US)

(72) Inventors: Tejinder Singh, Manotick (CA); Harpreet S. Narula, Austin, TX (US); Navjot Kaur Khaira, Manotick (CA)

(73) Assignee: Dell Products LP, Round Rock, TX (US)

(21) Appl. No.: 19/027,929

(22) Filed: Jan. 17, 2025

(51) Int. Cl. G06F 9/445

(52) U.S. Cl. CPC G06F 9/44505

(57) ABSTRACT

A system and method of maximizing throughput in an environment with a reconfigurable metasurface unit cell array on an information handling system including, with a hardware processor or a hardware controller of the information handling system, executing machine-readable program code instructions of a metasurface adaptive wireless beamforming system module to monitor movement of an information handling system to determine when detected movement of the information handling system exceeds a movement threshold. Initiating a radiofrequency throughput scan to determine when reflected electromagnetic EM wave direction from the reconfigurable metasurface unit cell array has been changed and determining location of radiofrequency source and target devices or low throughput zones relative to the reconfigurable metasurface unit cell array to reconfigure the electromagnetic reflective properties of the reconfigurable metasurface unit cell array to reflect EM wave towards the target device or the low throughput zone within a radiofrequency environment of the information handling system.

### FIELD OF THE DISCLOSURE

The present disclosure generally relates to a non-volatile reconfigurable metasurface. The present disclosure more specifically relates systems and methods for automatically reconfiguring a non-volatile reconfigurable metasurface based on movement of an information handling system to adjust reflected electromagnetic (EM) waves for radiofrequency signals.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used for wireless communications including transmission and reception of radiofrequency data signals via wireless radio systems.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system wirelessly interfacing with a reconfigurable metasurface unit cell array comprising a plurality of reconfigurable metasurface unit cells according to an embodiment of the present disclosure;

FIG. 2 is a block and graphic diagram illustrating a metasurface adaptive wireless beamforming system module executed by a hardware processor of the information handling system to control the configuration of the non-volatile reconfigurable metasurface unit cell array according to an embodiment of the present disclosure;

FIG. 3A is an exploded graphic diagram illustrating a perspective view of a reconfigurable metasurface unit cell of a reconfigurable metasurface unit cell array according to an embodiment of the present disclosure;

FIG. 3B is a side, exploded graphic diagram illustrating a partial cross-section view a reconfigurable metasurface unit cell of a reconfigurable metasurface unit cell array according to another embodiment of the present disclosure;

FIG. 4A is a top view graphic diagram showing a plurality of metasurface reconfigurable unit cell rings of a reconfigurable metasurface unit cell according to an embodiment of the present disclosure;

FIG. 4B is a top view diagram showing a plurality of contact pads of a reconfigurable metasurface unit cell according to an embodiment of the present disclosure;

FIG. 5 is graphic diagram of a top view of a plurality of reconfigurable metasurface unit cells of a reconfigurable metasurface unit cell array depicting various activation states of the plurality of unit cells according to an embodiment of the present disclosure;

FIG. 6 is a graphic diagram of a side, exploded view of a plurality of reconfigurable metasurface unit cells of a reconfigurable metasurface unit cell array according to another embodiment of the present disclosure;

FIG. 7 graphic diagram of a reconfigurable metasurface unit cell array on an information handling system and electromagnetic wave emission properties according to an embodiment of the present disclosure;

FIG. 8 is a graphic diagram of directionality of various emission states of a reconfigurable metasurface unit cell array operated by a digital-to-analog converter (DAC) and a field programmable gate array (FPGA) or other metasurface hardware controller according to an embodiment of the present disclosure;

FIG. 9 is a graphic diagram of a resulting angle of a electromagnetic (EM) beam emitted from the non-volatile reconfigurable metasurface unit cell array on an information handling system as the position of the information handling system is changed relative to a receiving device or a low throughput zone within a radiofrequency environment according to an embodiment of the present disclosure;

FIG. 10 is a graph depicting one or more movement thresholds of movement of an information handling system with non-volatile reconfigurable metasurface unit cell array to determine if and when a reflected electromagnetic (EM) wave is to be reconfigured to beamform towards a receiving device or a low throughput zone within a radiofrequency environment according to an embodiment of the present disclosure;

FIG. 11 is a block diagram of a method for executing machine readable code instructions of a metasurface adaptive wireless beamforming system module to control a reconfigurable metasurface unit cell array to dynamically change the directionality and feed distance of reflected EM wave beams for radiofrequency signals according to an embodiment of the present disclosure; and

FIG. 12 is a block diagram of a method for executing machine readable code instructions of a metasurface adaptive wireless beamforming system module to maximize throughput in a radiofrequency environment with adjustments to a reconfigurable metasurface unit cell array according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid wireless data transmission and communication between multiple devices. Devices may include wirelessly enabled information handling systems, access point devices, or any computing device, such as internet of things (IoT) devices that are wirelessly capable. As data transmission requirements increase, the electromagnetic (EM) wave radiofrequencies (e.g., 5G technologies using 20 to 50 GHz wireless signals or WiFi 6 signals at 2.4 GHz, 5 GHz or even 6 GHz) used to transmit these ever-increasing amounts of data are shortened or may benefit from extended range such as to reach around radiofrequency barriers such as walls. However, the ability to penetrate walls and building structures as well as transmit around these relatively large structures may be limited with such wireless systems. Additionally, material properties of these buildings and other structures effect reflection from, and transmission of, EM waves through building materials and on the absorption of EM wave energy in those materials, which gives rise to attenuation of the EM signal. Other EM wave-inhibiting mechanisms include diffraction from the edges of materials and scatter from rough edges also that exist in radiofrequency environments such as rooms within a building. Further, most buildings behave as lossy dielectrics as building materials as well as occasionally conductive material that further inhibit or scatter EM wave propagation.

With the advent of massive multiple input multiple output (MIMO) wireless technologies, a group of antennas at both the transmitting device and receiving device may provide high spectral and energy efficient wireless communication systems. In an embodiment of the present disclosure, a series of thin surfaces or panels can be installed on building surfaces or other surfaces within a radiofrequency environment that may be used to steer these EM waves and expand wireless range or signal quality. Some of these surfaces may include metasurface unit cells in arrays referred to as metasurface arrays herein. Further, embodiments of the present disclosure may include reconfigurable intelligent surfaces (RISs) or “reconfigurable metasurfaces” or “reconfigurable metasurface unit cell arrays” that include engineered materials designed to have properties not found in naturally occurring materials to allow for reconfigurability of reconfigurable metasurface unit cells in embodiments of the present disclosure. These reconfigurable metasurfaces are crafted and adjusted with a control system to manipulate EM waves in ways that non-reconfigurable metasurface unit cells cannot, thereby often achieving effects like negative refraction as well as control over directionality of reflection and redirection of EM waves of the radiofrequency signals in embodiments of the present disclosure.

The reconfigurable metasurfaces of embodiments of the present disclosure may be used within current infrastructures having radiofrequency environments within, for example, office settings or home settings where radiofrequency data communication could benefit from these reconfigurable metasurfaces relaying EM wave transmissions around corners, into various office spaces, and/or into various rooms. In some previous examples of reconfigurable unit cells, the use of PIN diodes and varactor diodes for reconfigurability causes these metasurfaces may have high losses, parasitic effects, and limited phase tunability. These components within the prior metasurface unit cell also complicate soldering and biasing in dense arrays thereby reducing performance and scalability and ability to function as described in embodiments herein due to power requirements or size limitations. These prior metasurfaces require continuous power supply increasing the power consumption associated with the metasurfaces. A more efficient, scalable, and precisely integrated reconfigurable metasurface is needed.

To address these and other issues, the present specification describes a reconfigurable metasurface to manipulate reflection of electromagnetic waves for radiofrequency signals. The reconfigurable metasurface may include a plurality of reconfigurable metasurface unit cells formed across the surface of the reconfigurable metasurface. In an embodiment, each reconfigurable metasurface unit cell may include a first metasurface reconfigurable split ring, a second metasurface reconfigurable split ring, and a third metasurface reconfigurable split ring as well as a conductive center node and a conductive outer ring. It is appreciated that any number of metasurface reconfigurable split rings may be formed into the reconfigurable metasurface unit cell, and the present specification also contemplates other form factors for metasurface reconfigurable split rings, for example differing shapes other than a rings, of each of the reconfigurable metasurface unit cells. In an embodiment, the metasurface reconfigurable split rings may be made of a phase change material that, when heated, changes from a first amorphous state to a second crystalline state, or vice-versa. Thus, when a temporary amount heat, such as a heat pulse, is applied to each of the metasurface reconfigurable split rings, individually, the phase change material may switch between a high resistance dielectric state to a low resistance conductive state or back again. Changing a selection of metasurface reconfigurable split rings between a conductive state and a dielectric state changes the operation of the reconfigurable metasurface unit cell between the conductive center node and conductive outer ring to adjust EM wave reflection directionality according to embodiments herein. In an embodiment, these phase change materials may include, for example, geranium telluride (GeTe), antimony telluride (SbTe), chalcogenide (GeSbTe), and the like. Application of heat may be applied for a short duration, or heat pulses, to switch the phase of these phase change materials back and forth between the high resistance dielectric state to the low resistance conductive state.

In order to heat, individually, each of the metasurface reconfigurable split rings, each of the reconfigurable metasurface unit cells may include a plurality of refractory heaters. In an example embodiment having three metasurface reconfigurable split rings, each reconfigurable metasurface unit cell includes a first refractory heater to selectably heat the first metasurface reconfigurable split ring to switch the first metasurface reconfigurable split ring between a conductive state and dielectric state, a second refractory heater to selectably heat the second metasurface reconfigurable split ring to switch the second metasurface reconfigurable split ring between a conductive state and dielectric state, and a third refractory heater to selectably heat the third metasurface reconfigurable split ring to switch the third metasurface reconfigurable split ring between a conductive state and dielectric state.

In an embodiment, a plurality of contact pads are included within each of the dielectric unit cells that operatively couple the first refractory heater, the second refractory heater, the third refractory heater to a metasurface power management unit (PMU) and a reconfigurable metasurface controller to provide power to the first refractory heater, the second refractory heater, and the third refractory heater to change the electromagnetic reflective properties of the metasurface. In an embodiment, a field programmable gate array (FPGA) or other metasurface hardware controller and digital-to-analog converter (DAC) may be used to control power provided to each of the first refractory heater, the second refractory heater, the third refractory heater. In this way, the FPGA or other metasurface hardware controller may control conductivity of each of the first metasurface reconfigurable split ring, the second metasurface reconfigurable split ring, and the third metasurface reconfigurable split ring within each reconfigurable metasurface unit cell by pulse heating for a brief duration in order to selectively switch each of these metasurface reconfigurable split rings between the amorphous state and the crystalline state. A second heating of a brief duration will selectively switch the phase change materials of each of these metasurface reconfigurable split rings back again to the previous state allowing for a toggle effect of conductivity for these metasurface reconfigurable split rings.

By switching each of the first metasurface reconfigurable split ring, second metasurface reconfigurable split ring, and third metasurface reconfigurable split ring between the amorphous state and the crystalline state, the reconfigurable metasurface unit cell array may be configured to redirect transmitted EM waves and beam steer those EM waves in a desired direction. In some situations, the metasurface may be placed on a surface of, for example, a laptop-type information handling system such as an A-cover or outer clamshell surface of a display chassis. By placing the reconfigurable metasurface on the outer surface of a lid or A-cover of the laptop-type information handling system, the reconfigurable metasurface may be used to redirect and reflect any incoming EM waves of radiofrequency signals toward another receiving device or towards a low throughput zone within a radiofrequency environment where that information handling system is present. However, as this laptop-type information handling system is moved or otherwise manipulated, the ability to redirect and reflect the EM wave towards these locations is inhibited or altered. To maintain a reflected direction of the EM wave of a radiofrequency signal, the information handling system may include a hardware processing resource to execute machine-readable program code of a metasurface adaptive wireless beamforming system module to determine if the movement of the information handling system exceeds at least one detected movement threshold. When detected movement has exceeded at least one movement threshold, the metasurface adaptive wireless beamforming system module executes to reconfigure the electromagnetic reflective properties of the reconfigurable metasurface to adjust directionality of a reflected EM wave of the radiofrequency signal with adjustment of one or more reconfigurable metasurface unit cells towards a low throughput zone within a radiofrequency environment.

The reconfigurable metasurface may be operatively coupled to the information handling system such that the information handling system may be used as a relay for EM wave propagation of radiofrequency signals by reflecting incoming EM waves towards another receiving device or towards a low throughput zone within a radiofrequency environment in which the information handling system is present. In an embodiment, the reconfigurable metasurface on the information handling system may include a metasurface adaptive wireless beamforming system module to, when executed by a hardware processor or metasurface controller, detect movement of the information handling system to determine if the movement of the information handling system exceeds a movement threshold. With detected movement exceeding a movement threshold, the reconfigurable metasurface unit cell array or the reconfigurable metasurface is reconfigured to direct lobes of reflected EM waves towards a low throughput zone within the radiofrequency environment based on directional radio signal strength indicator (RSSI) measurements within the radiofrequency environment by the reconfigurable metasurface and a radio system or radio frequency sensor of the information handling system. In an embodiment, a plurality of sensors to detect the movement of the information handling system and a platform controller hub (PCH) of the information handling system receives output from those plurality of sensors to determine that the movement of the information handling system has exceeded the movement threshold, and, using the received signal strength indicator (RSSI) data from a radio frequency sensor, determine the low throughput zone within the radiofrequency environment of the information handling system.

Thus, the presently-described reconfigurable metasurface unit cell array of embodiments herein is real-time configurable and can optimize signal direction and phase continuously with execution of the metasurface adaptive wireless beamforming system module to respond to a dynamic wireless environment. The switching time of the phase change material between amorphous states and crystalline states of the reconfigurable metasurface unit cell of embodiments herein is in nanoseconds resulting in the reconfiguration time of the reconfigurable metasurface unit cell array being completed within a sub-millisecond timeframe. Still further, the reconfigurable metasurface unit cell array of embodiments herein is energy efficient with the power only being required intermittently during the reconfiguration phase when the first refractory heater, the second refractory heater, the third refractory heater are actuated to pulse heat the reconfigurable metasurface controller requires low power from a PMU and power source. Once the appropriate refractory pattern is achieved, the phase change materials retain their state without the need for ongoing power applied. The reconfigurable metasurface unit cell array of embodiments herein is also more easily scalable via use of the integrated first refractory heater, the second refractory heater, the third refractory heater, or other refractory heaters as needed in a network among the plurality of reconfigurable metasurface unit cells in any scalable array size. Complication of forming the reconfigurable metasurface unit cells is minimal as is the power requirements for operation.

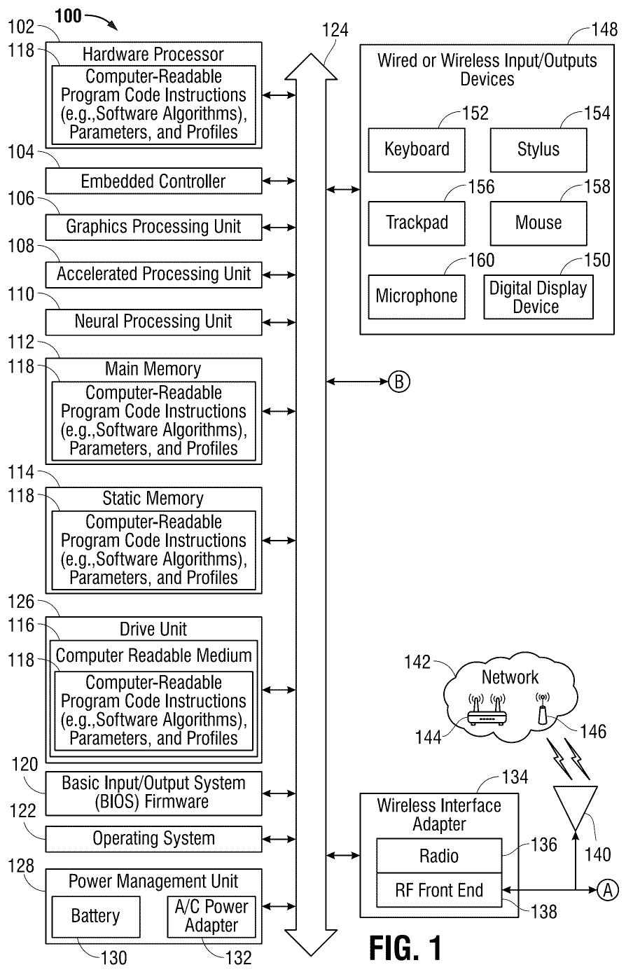

Turning now to the figures, FIG. 1 illustrates an information handling system 100 similar to the information handling systems according to several aspects of the present disclosure that may operate as a source or target radiofrequency device for use with the reconfigurable metasurfaces of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Machine-readable code instructions stored in main memory 112 (e.g., RAM) may be accessible by hardware processing resources using that main memory 112. Machine-readable program code instructions stored in static memory 114, main memory 112, or drive unit 126 may be involved in invoking such machine-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine-readable program code instructions (e.g., software algorithms) parameters, and profiles 118 that may operate on servers or systems, remote data centers, or on-box in individual client information handling systems according to various embodiments herein. In some embodiments, it is understood any or all portions of machine-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute machine-readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with machine-readable medium 116 storing machine-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via enhanced radiofrequency propagation with reflection using the reconfigurable metasurface unit cell array 162. In other embodiments, the reconfigurable metasurface unit cell array 162 may operate to reflect EM waves of radiofrequency signals between other receiver devices 178 or an AP 144 or base station 146 within a radiofrequency environment in embodiments herein. For example, the receiver device 178 may be any other device and may include the AP 144, the base station 146, or any other computing device described herein. Additionally, the information handling system 100 and receiver device 178 may be capable of transmitting wireless data using, for example, radiofrequency signals in EM waves that include 5G mm wave lengths such as those included within the 20-50 GHz range or WiFi wavelengths such as 2.4 GHz, 5 GHz, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes machine-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a machine-readable medium that includes machine-readable program code instructions, parameters, and profiles 118 or receives and executes machine-readable program code instructions, parameters, and profiles 118 responsive to a propagated signal, so that a hardware device connected to a network 142 may communicate voice, video, or data over the network 142. Further, the machine-readable program code instructions, parameters, and profiles 118 may be transmitted or received over the network 142 via the network interface device or wireless interface adapter 134.

The information handling system 100 or a reconfigurable metasurface unit cell array 162 may include a set of machine-readable program code instructions, parameters, and profiles 118 that may be executed to cause the computer system to perform any one or more of the methods or computer-based functions disclosed herein. For example, the machine-readable program code instructions of a metasurface adaptive wireless beamforming system module may be executed by a hardware processor 102, GPU 106, EC 104, APU 108, NPU 110, or any other hardware processing resource as well as by a metasurface controller 187, such as a FPGA according to embodiments herein. In other examples, machine-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a machine-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain machine-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain machine-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the machine-readable medium is shown to be a single medium, the term “machine-readable medium” includes a single medium or multiple media, such as a centralized or distributed database, and/or associated caches and servers that store one or more sets of machine-readable code instructions. The term “machine-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the machine-readable medium can include a solid-state memory such as a memory card or other package that houses one or more non-volatile read-only memories. Further, the machine-readable medium can be a random-access memory or other volatile re-writable memory. Additionally, the machine-readable medium can include a magneto-optical or optical medium, such as a disk or tapes or other storage device to store information received via carrier wave signals such as a signal communicated over a transmission medium. Furthermore, a machine-readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a machine-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may operatively communicate with a receiver device 178 (e.g., another information handling system, an AP 144, a base station 146, etc.) for facilitate radiofrequency signal communications between receiver devices 178, an AP 144, or base station 146 as an intermediary-placed reconfigurable metasurface unit cell array 162 in the information handling system 100. This reconfigurable metasurface unit cell array 162 may be configured to relay or otherwise reflect wireless EM waves transmitted from the information handling system 100 and may extend the wireless range or improve signal of the information handling system 100 in communications with a target wireless receiver device 178. Again, these EM waves may include any type of EM wave including low-band, mid-band, or high-band millimeter-wave EM waves. These may include 600-900 MHz, 1.7-6 GHz, and 24-47 GHz, among other frequencies.

The reconfigurable metasurface unit cell array 162 may include a plurality of reconfigurable metasurface unit cells, such as the first reconfigurable metasurface unit cell 164-1 and a second reconfigurable metasurface unit cell 164-2 is shown in FIG. 1. It is appreciated that the reconfigurable metasurface unit cell array 162 may contain any number of reconfigurable metasurface unit cells 164-1, 164-2. In one example embodiment, the reconfigurable metasurface unit cell array 162 may contain two-hundred and fifty-six reconfigurable metasurface unit cells 164-1, 164-2 arranged in a sixteen-by-sixteen array. It is appreciated that the reconfigurable metasurface unit cell array 162 may include any plurality of reconfigurable metasurface unit cells 164-1, 164-2 in any arrangement of those unit cells 164-1, 164-2. As described herein, the reconfigurable metasurface unit cells 164-1, 164-2 within the reconfigurable metasurface unit cell array 162 may be used to, in real-time, to reconfigure its reflective properties to control the refection and steering of incoming EM waves from a transmitting source (e.g., the wireless antenna 140 of the wireless interface adapter 134 of the information handling system 100) to a receiver device 178 according to embodiments herein.

In an embodiment, each of the reconfigurable metasurface unit cells 164-1, 164-2 may include a first metasurface reconfigurable split ring 166-1, a second metasurface reconfigurable split ring 166-2, and a third metasurface reconfigurable split ring 166-3. In an embodiment, each of the metasurface reconfigurable split rings 166-1, 166-2, 166-3 may be made of a non-volatile phase change material and a conductive bridge to complete each split ring. This phase change material may include, for example, germanium telluride (GeTe), antimony telluride (SbTe), or chalcogenide (GeSbTe) among other similar non-volatile phase change materials. The non-volatile phase change material of the metasurface reconfigurable split rings 166-1, 166-2, 166-3 may have two distinct states: an amorphous state and a crystalline state. In an embodiment, when the non-volatile phase change materials are in an amorphous state, the metasurface reconfigurable split rings 166-1, 166-2, 166-3 have a high resistance for a dielectric state. In an embodiment, when the non-volatile phase change materials are in a crystalline state, the metasurface reconfigurable split rings 166-1, 166-2, 166-3 may have a low resistance for a conductive state. In an embodiment, switching between the amorphous state and the crystalline state may be achieved via application of thermal energy from one of a plurality of refractory rings that, in an embodiment, includes a first refractory heater 168-1, a second refractory heater 168-2, and a third refractory heater 168-3 corresponding to each metasurface reconfigurable split ring 166-1, 166-2, 166-3 described herein. In an embodiment, the non-volatile phase change materials may hold a state as long as it is not actuated with another heat pulse to transition to the alternate state as either the amorphous state or the crystalline state.

In an embodiment, each of the metasurface reconfigurable split rings 166-1, 166-2, 166-3 may be selectively switched from a conductive state to an dielectric state in order to modify constructive and/or destructive interference of the metasurface reconfigurable split rings 166-1, 166-2, 166-3 with the center conductive node and outer conductive ring on the incoming EM wave thereby reflectively steering the EM wave in a specific direction such as in the direction of the receiver device 178. Via the use of the constructive and/or destructive interference, any number of EM wave beam directions may be created that may be used to increase the feed distance of the EM wave beams in order to expand radiofrequency signal range or focus the directionality of the EM wave beams for the radiofrequency signals in an radiofrequency environment. In an embodiment, the directionality and feed distance of the EM wave beams may be changed (e.g., the array of reconfigurable metasurface unit cells 164-1, 164-2 may be reconfigured) within sub-milliseconds such that data may be transmitted to various different locations within an area.

As described in embodiments herein, each of the reconfigurable metasurface unit cells 164-1, 164-2 may include a first refractory heater 168-1, a second refractory heater 168-2, and a third refractory heater 168-3 to, each, selectively apply heat pulses to the first metasurface reconfigurable split ring 166-1, the second metasurface reconfigurable split ring 166-2, and the third metasurface reconfigurable split ring 166-3, respectively. In an embodiment, each of the refractory heaters 168-1, 168-2, 168-3 may be made of tungsten (W). In an embodiment, the first metasurface reconfigurable split ring 166-1, the second metasurface reconfigurable split ring 166-2, and the third metasurface reconfigurable split ring 166-3 are formed into a first layer with the first refractory heater 168-1, the second refractory heater 168-2, and the third refractory heater 168-3 formed into a second layer and electrically insulated. In an embodiment, the first layer is separated from the second layer by a dielectric layer made of, for example, silicon nitride (SiNx) or aluminum nitride (AlN). This dielectric layer may act as an electric insulator that prevents the flow of electric current from the refractory heaters 168-1, 168-2, 168-3 but be thermally conductive.

In an embodiment, each of the refractory heaters 168-1, 168-2, 168-3 are operatively coupled to a contact pad 170. The contact pads 170 may serve as a contact pad through which a metasurface PMU 172, as controlled with metasurface controller 187 may provide power to each of the refractory heaters 168-1, 168-2, 168-3 to generate heat pulses for each of the respective reconfigurable metasurface unit cells 164-1, 164-2. In an embodiment, additional layers may be formed below the refractory heaters 168-1, 168-2, 168-3. In an embodiment, these layers may include an electrical dielectric substrate made of, for example, high-resistivity silicon (HRSi), aluminum oxide (Al₂O₃), glass, or printed circuit board among others placed below the second layer. These layers may be thermally insulative. In an embodiment, a metallization layer used as a radio frequency (RF) ground may be placed below the electrical dielectric substrate and may be made of copper or other metal. Another dielectric layer made of, for example, silicon dioxide (SiO₂) may be placed below the metallization layer and above the contact pads 170. Thus, in an embodiment, a number of vias are formed through the electrical dielectric substrate, the metallization layer with isolation, and the dielectric layer below the refractory heaters 168-1, 168-2, 168-3 so that the contact pads 170 may be operatively coupled to the refractory heaters 168-1, 168-2, 168-3 via one or more metal interconnects.

In an embodiment, each of the reconfigurable metasurface unit cells 164-1, 164-2 may include other structures used to redirect transmitted EM waves and beam steer those EM waves in a desired direction. In an example embodiment, the reconfigurable metasurface unit cells 164-1, 164-2 may each include a non-reconfigurable metal fixed outer ring formed around the metasurface reconfigurable split rings 166-1, 166-2, 166-3 described herein. The non-reconfigurable metal fixed outer ring may form a passive conductive ring such that it does not require power from the metasurface PMU 172 to maintain its characteristics to contribute to the redirection of the transmitted EM waves and beam steering of those EM waves in a desired direction. In an embodiment, along with the non-reconfigurable metal fixed outer ring, each of the non-reconfigurable metal fixed split ring unit cells 164-1, 164-2 may also include a non-reconfigurable metal fixed center node formed within each of the first metasurface reconfigurable split ring 166-1 of each reconfigurable metasurface unit cell 164-1, 164-2 to also act as a passive conductive dot or pad such that it does not require power from the metasurface PMU 172 to maintain its characteristics to contribute to the redirection of the transmitted EM waves and beam steering of those EM waves in a desired direction.

As described herein, the reconfigurable metasurface unit cell array 162 may be operatively coupled to a metasurface PMU 172 and controlled via a metasurface controller 187 that may be a field programmable gate array (FPGA) circuit microchip or other hardware controller at the reconfigurable metasurface unit cell array 162. Like the PMU 128 of the information handling system 100, the metasurface PMU 172 may include control from the metasurface controller 187 to provide power to each of the refractory heaters 168-1, 168-2, 168-3 for triggered heat pulses via one or a combination of both a metasurface battery 174 and metasurface A/C power adapter 176. In an embodiment, the power needed to operate the reconfigurable metasurface unit cell array 162 may be low such that the metasurface battery 174 may be sufficient to pulse heat to the individual refractory heaters 168-1, 168-2, 168-3 in order to switch the metasurface reconfigurable split rings 166-1, 166-2, 166-3 from an amorphous state to a crystalline state or vice versa.

By switching each of the metasurface reconfigurable split rings 166-1, 166-2, 166-3 between the amorphous state and the crystalline state, the reconfigurable metasurface unit cell array 162 may be configured to redirect transmitted EM waves and beam steer those EM waves in a desired direction and may be controlled via the metasurface controller 187. Additionally, because the heating of the phase change material of the metasurface reconfigurable split rings 166-1, 166-2, 166-3 can be achieved by applying thermal energy such as a pulse with a certain amplitude and width (on the order of nanoseconds) through the electrically insulated high-speed, refractory heaters 168-1, 168-2, 168-3, the constant application of power is not needed thereby reducing the need for a dedicated power source. Indeed, in some embodiments, these phase change materials of the metasurface reconfigurable split rings 166-1, 166-2, 166-3 hold their states as long as it is not actuated with another heat pulse to change to the other crystalline or amorphous phase.

In an embodiment, the reconfigurable metasurface unit cell array 162 may be coupled to an outer surface of the information handling system 100, for example the outer surface of a display chassis of a laptop or table style information handling system 100, such that the reconfigurable metasurface unit cell array 162 may be used to relay incoming EM waves radiofrequency signals to other locations. These other locations may be locations within a radiofrequency environment such as towards other information handling systems such as target receiver devices 178 or to a low throughput zone within the environment from a source radiofrequency signal location such as an AP 144 or base station 146. By allowing the reconfigurable metasurface unit cell array 162 placed on the information handling system 100 to act as an EM wave relay point, the radiofrequency environment that the information handling system 100 is within may be capable of transmitting those high frequency EM waves around corners and across larger distances with effective RSSI radiofrequency signals. In an embodiment, the information handling system 100 may be a laptop-type information handling system 100 and the reconfigurable metasurface unit cell array 162 may be coupled to a surface of the A-cover of the lid or top of a display panel chassis of the information handling system 100 such that, when opened, the information handling system 100 may present a flat surface for the reconfigurable metasurface unit cell array 162 to redirect incoming EM waves to those locations within the radiofrequency environment described herein.

During operation, however, the user may move the information handling system 100 such that the orientation of the reconfigurable metasurface unit cell array 162 has changed. This may a result of the user altering the orientation of the information handling system 100 by adjusting the lid portion of the information handling system 100 relative to the base portion, changing the angle of the base portion relative to a previous location, or generally moving the location of the information handling system 100 within the environment. Because the location of the reconfigurable metasurface unit cell array 162 has changed, the current orientation and angle of the beam emitted from the reconfigurable metasurface unit cell array 162 no longer is directed towards another information handling system, such as target receiver device 178, or towards the low throughput zone from a radiofrequency signal source such as AP 144 or a base station 146. The reconfigurable metasurface unit cell array 162 may, in an embodiment, change the direction and magnitude of the reflected EM beam by correcting for those changes in position and location of the information handling system 100 and, accordingly, the reconfigurable metasurface unit cell array 162. In an embodiment, the hardware processor 102 of the information handling system 100 may execute machine-readable program code instructions of a metasurface adaptive wireless beamforming system module 180 along with the metasurface controller 187 to determine and make automatic adjustments to the reconfigurable metasurface unit cell array 162 according to embodiments herein. Execution of the machine-readable program code instructions of the metasurface adaptive wireless beamforming system module 180 causes the information handling system 100 to detect movement of the information handling system 100, determine if the movement of the information handling system 100 exceeds a movement threshold, and reconfigure the electromagnetic reflective properties of the reconfigurable metasurface unit cell array 162 to reconfigure a reflected EM waves of radiofrequency signals towards a low throughput zone within the radiofrequency environment upon movement of the information handling system above one or more movement thresholds. Triggering a radiofrequency throughput scan by execution of the machine-readable program code instructions of the metasurface adaptive wireless beamforming system module 180 using the radiofrequency sensor may determine location of a low throughput zone, but execution of this radiofrequency throughput scan is minimized to only when threshold levels of movement of the information handling system 100 are detected in embodiments herein.

In an embodiment, in order to detect movement of the information handling system 100, the information handling system 100 may include a plurality of sensors. These sensors may include, for example, a proximity sensor, a hall sensor, a gyroscope, an accelerometer, and an RF radio sensor, among other sensors. In an embodiment, the proximity sensor may detect a change in distance between or orientation relative to an access point 144 or base station 146 indicating a change in location of the information handling system 100 within the environment. In an embodiment, the hall sensor may be used to detect changes and current orientation of, for example, the lid of the laptop-type information handling system 100 relative to the base of the laptop-type information handling system 100. Thus, in an embodiment, the hall sensor may determine, at least, whether the lid of the information handling system 100 is closed or open as well as the relative positioning of the lid to the base. In an embodiment, the gyroscope may provide data describing the orientation of the information handling system 100 as a whole as well as changes in the orientation of the information handling system 100. In an embodiment, the accelerometer may provide data describing acceleration of the information handling system 100 as movement of the information handling system 100 is detected. This acceleration data may be used to determine how far the information handling system 100 has moved as well as the velocity and duration of movement of the information handling system 100 at any given time. In an embodiment, the RF radio sensor may provide data describing received signal strength indicator (RSSI) values that may indicate where other information handling systems 100, such as target receiver devices 178, APs 144 or base stations 146 are located within the radiofrequency environment or those low throughput zones within the radiofrequency environment.

In an embodiment, the data received from each of the sensors may be aggregated at a sensing hub module (not shown) on a platform control hub. The sensing hub module may interface with a metasurface configuration sensor (discussed further below) that will reconfigure the reconfigurable metasurface unit cell array 162. The metasurface configuration sensor provides data to a metasurface hardware controller 187 of the reconfigurable metasurface unit cell array 162 to reconfigure one or more reconfigurable metasurface unit cells 164-1, 164-2 within the reconfigurable metasurface unit cell array 162 to redirect the EM beam towards the other information handling system or to a detected low throughput zone within an environment in which the information handling system 100 is present.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

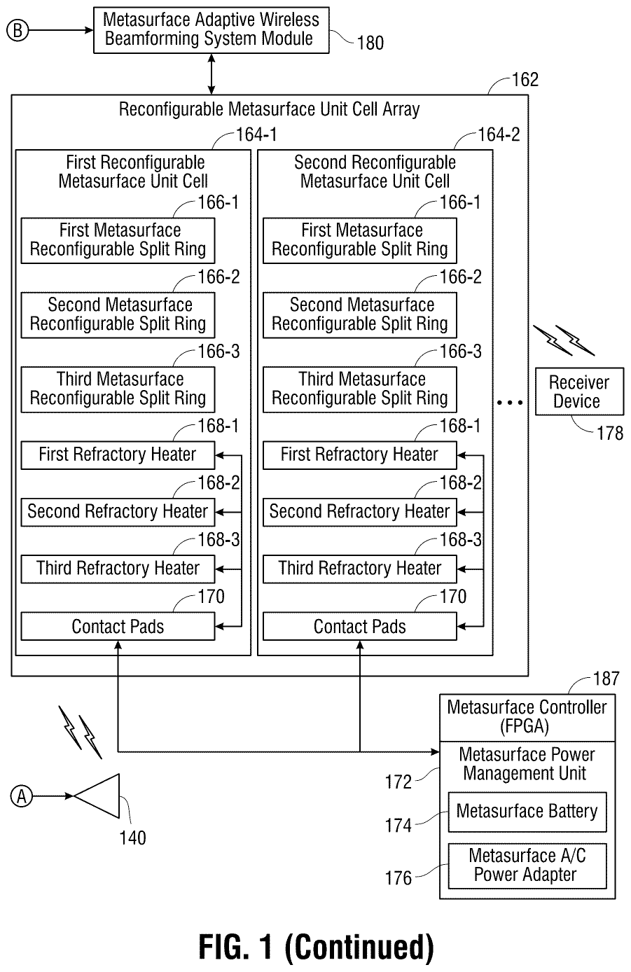

FIG. 2 is a block and graphic diagram illustrating an information handling system and a reconfigurable metasurface unit cell array under control of a metasurface adaptive wireless beamforming system module executed by a hardware processor of the information handling system and a metasurface controller to control the configuration of the non-volatile reconfigurable metasurface according to an embodiment of the present disclosure. FIG. 2 shows the information handling system 200 as a laptop-type information handling system 200 that may include a digital display device 250 and a keyboard 252 as an output and input device, respectively. The laptop-type information handling system 200 allows for the operative coupling of the reconfigurable metasurface unit cell array 262 to the information handling system 200 on a surface of the lid portion or A-cover 283 of a display chassis of the information handling system 200. In an embodiment, the information handling system 200 may be operatively coupled to the reconfigurable metasurface unit cell array 262 and the metasurface controller 287 via the wireless interface adapter 234, radio 236, RF front end 238, and wireless antenna 240 interfacing with a metasurface wireless interface adapter 279 and metasurface wireless antenna 277. Additionally, or alternatively, the information handling system 200 may be operatively coupled to the reconfigurable metasurface unit cell array 262 and the metasurface controller 287 via a hardware connection such as a wired connection 276 passing through the A-cover 283. In this embodiment, the PMU (e.g., 128, FIG. 1) of the information handling system 200 may provide power to the reconfigurable metasurface unit cell array 262 instead of the reconfigurable metasurface unit cell array 262 using a metasurface PMU and separate power source (e.g., 172, FIG. 1).

As described herein, the hardware processor 202 of the information handling system 200 operating with the metasurface controller 287 may execute machine-readable program code instructions of a metasurface adaptive wireless beamforming system module 280. Execution of the machine-readable program code instructions of the metasurface adaptive wireless beamforming system module 280 causes the information handling system 200 to detect movement of the information handling system 200, determine if the movement of the information handling system 200 exceeds a movement threshold, and reconfigure the electromagnetic reflective properties of the reconfigurable metasurface unit cell array 262, via the metasurface controller 287, to reconfigure directionality of reflected EM waves of radiofrequency signals towards a low throughput zone from a radiofrequency signal source such as an AP, base station, the information handling system 200, or another wireless device within an radiofrequency environment where the information handling system 200 is present.

During operation and in order to detect movement of the information handling system 200, the information handling system 200 may include a plurality of sensors. In an embodiment, these sensors may include a proximity sensor 275. The proximity sensor 275 may be operatively coupled to a Wi-Fi sensing driver 273. In an embodiment, the proximity sensor 275 may, via the Wi-Fi sensing driver 273, provide data to a sensing hub module 271 describing a change in distance between or orientation relative to an access point (e.g., 144, FIG. 1) or base station (e.g., 146, FIG. 1) indicating a change in location of the information handling system 200 within the environment. It is appreciated that this proximity sensor may also use a global positioning system (GPS) to define the location of the information handling system 200 within an environment. It is appreciated that any other positioning system may be used and that the proximity sensor 275 may be operatively coupled to these other types of sensors to determine the location of the information handling system 200.

In an embodiment, the information handling system 200 may also include a hall sensor. In an embodiment, the hall sensor 269 may be used to detect changes and current orientation of, for example, the lid of the laptop-type information handling system 200 that includes the a-cover 283 and the reconfigurable metasurface unit cell array 262 relative to the base of the laptop-type information handling system 200. Thus, in an embodiment, the hall sensor 269 may determine, at least, whether the lid of the information handling system 200 is closed or open as well as the relative positioning of the lid to the base. The data from the hall sensor 269 may be provided to the sensing hub module 271 via a system configuration driver 267.

In an embodiment, the metasurface adaptive wireless beamforming system module 280 may interface with a gyroscope 265. In an embodiment, the gyroscope 265 may, via a motion detection driver 263, provide data describing the orientation of the information handling system 200 as a whole as well as changes in the orientation of the information handling system 100. Again, this data may be provided to the sensing hub module 271 for further processing as described herein.

In an embodiment, the information handling system 200 may also include an accelerometer 261. In an embodiment, the accelerometer 261 may, via the motion detection driver 263, for example, provide data describing acceleration of the information handling system 200 as movement of the information handling system 200 is detected. This acceleration data may be used to determine how far the information handling system 200 has moved as well as the velocity and duration of movement of the information handling system 200 at any given time. As described herein, this data may also be used by the sensing hub module 271 to define whether the movement threshold has been met or exceeded as described herein.

In an embodiment, the information handling system may also include an RF radio sensor 257. In an embodiment, the RF radio sensor 257 may provide data, via a wireless radio driver 255 for example, that describes any RSSI values via a radiofrequency throughput scan of radiofrequency signals in a radiofrequency environment, that may indicate where other information handling systems are located within the radiofrequency environment, such as radiofrequency signal source devices, or those low throughput zones within the radiofrequency environment. These RSSI values may also be provided to the sensing hub module 271 for later processing as described herein.

It is appreciated that other sensors may also be used that may help to define the position and orientation of the information handling system 200. For example, a camera may be used to detect the presence of a human near the information handling system 200 that provides data to the sensing hub module 271 via a human presence driver 259. Presence of a human such as the user of the information handling system 200 may be used to determine if distortions in the RSSI values are anticipated such that the sensing hub module 271 may accommodate or otherwise adjust the RSSI values based on human presence.

In an embodiment, the data received from each of the sensors may be aggregated at a sensing hub module 271 on a platform control hub 253. The sensing hub module 271 may interface with a metasurface configuration sensor 251 that will reconfigure the reconfigurable metasurface unit cell array 262. The metasurface configuration sensor 251 provides data to a metasurface hardware controller 287 of the reconfigurable metasurface unit cell array 262 and/or the hardware processor 202 of the information handling system 200 to reconfigure one or more reconfigurable metasurface unit cells (e.g., 164-1, 164-2) within the reconfigurable metasurface unit cell array 262. This reconfiguration of the reconfigurable metasurface unit cell array 262 may redirect the EM beam towards the other information handling systems or to a detected low throughput zone within an environment the information handling system 200 is present. It is appreciated that any metasurface context aware and configuration software applications 249 may also be used to calculate if and how the reconfigurable metasurface unit cell array 262 is to be reconfigured. For example, the metasurface context aware and configuration software applications 249 may include any artificial intelligence (AI) modules and/or machine learning (ML) model algorithms that may receive the data from each of the sensors and provide, as output, beamforming data that is sent to the metasurface controller 287 and/or hardware processor 202 to reconfigure the reconfigurable metasurface unit cells of the reconfigurable metasurface unit cell array 262 to change the EM wave beam 247 as directed.

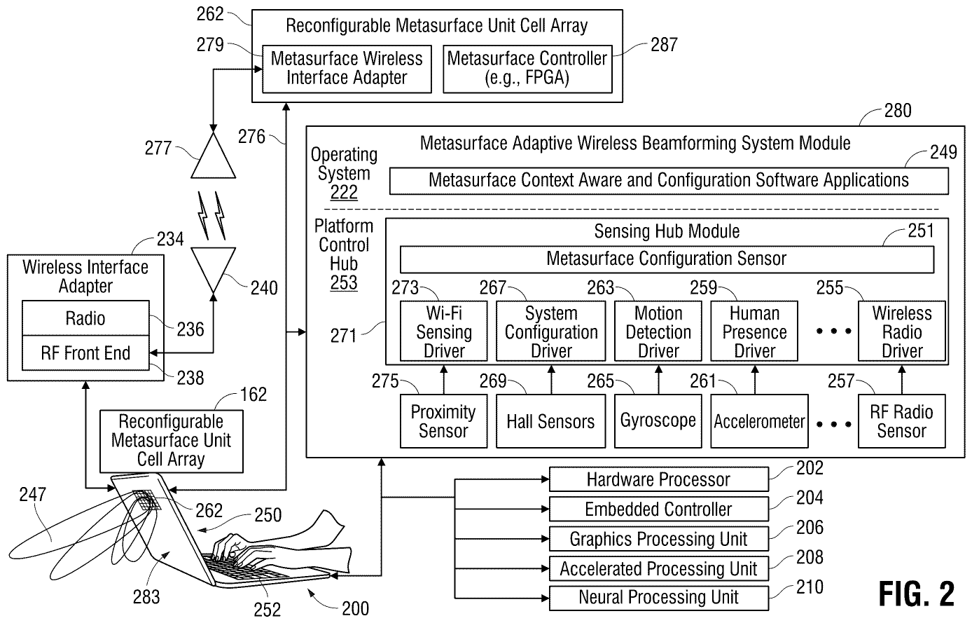

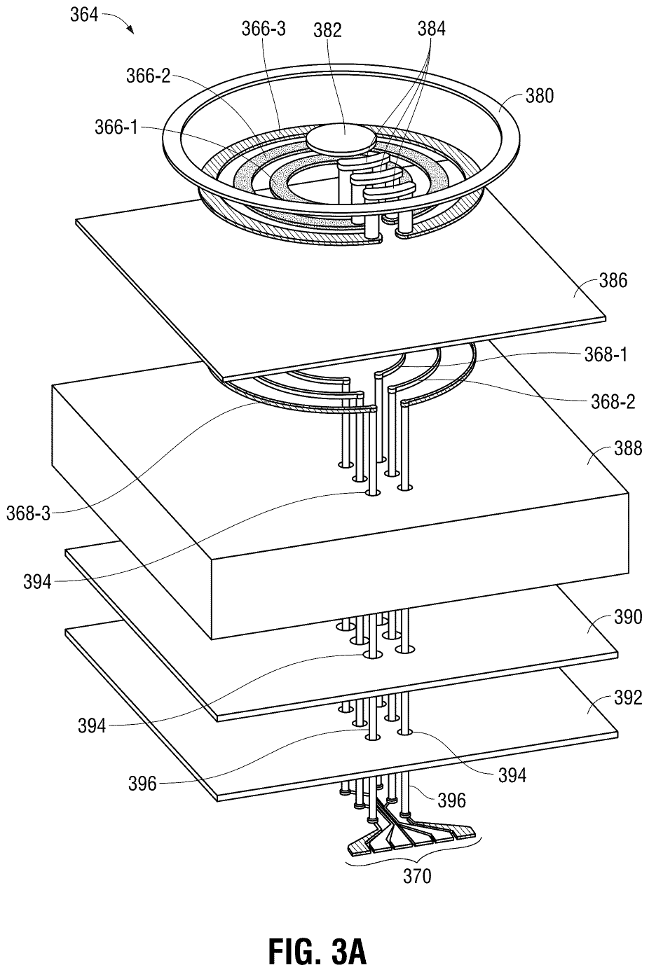

FIG. 3A is an exploded graphic diagram perspective view illustrating a reconfigurable metasurface unit cell of a reconfigurable metasurface unit cell array according to an embodiment of the present disclosure. Additionally, FIG. 3B is a side, exploded graphic diagram cross-section illustrating a reconfigurable metasurface unit cell of a reconfigurable metasurface unit cell array according to another embodiment of the present disclosure. It is appreciated that each of the reconfigurable metasurface unit cells 364 of the reconfigurable metasurface unit cell array (e.g., FIGS. 1, 162) may comprise their own various layers or may, in an embodiment, share the same layer or layers. Again, the reconfigurable metasurface unit cell 364 shown in FIGS. 3A and 3B may be one of a plurality of reconfigurable metasurface unit cells 364 that form the reconfigurable metasurface unit cell array and may include any number of reconfigurable metasurface unit cells 364 arranged in any manner forming a two-dimensional structure.

As shown in FIGS. 3A and 3B, the reconfigurable metasurface unit cell 364 includes concentrically formed first metasurface reconfigurable split ring 366-1, second metasurface reconfigurable split ring 366-2, and third metasurface reconfigurable split ring 366-3 on a first layer of the reconfigurable metasurface unit cell 364. Each of these metasurface reconfigurable split rings 366-1, 366-2, 366-3 may include any phase change materials such as GeTe, SbTe, or GeSbTe among other similar non-volatile phase change materials and a conductive bridge 384 to complete the ring. The metasurface reconfigurable split rings 366-1, 366-2, 366-3 share the same layer as the non-reconfigurable metal fixed ring 380, arranged as an outer ring in some embodiments or another location in other embodiments, and non-reconfigurable metal fixed center node 382. These metasurface reconfigurable split rings 366-1, 366-2, 366-3, the non-reconfigurable metal fixed ring 380, and non-reconfigurable metal fixed center node 382 act together to control and focus the directionality of the EM wave beams reflected off of the reconfigurable metasurface unit cell array. In an embodiment, the non-reconfigurable metal fixed ring 380 and non-reconfigurable metal fixed center node 382 may be made of a metal such as gold (Au), copper (Cu), aluminum (Al), nickel (Ni) among other types of conductive metals.

In an embodiment, each of the metasurface reconfigurable split rings 366-1, 366-2, 366-3 may include a split or gap along the circumference of the metasurface reconfigurable split rings 366-1, 366-2, 366-3. As shown in FIG. 3A, for example, this gap correlates with a gap in each of the respective refractory heaters 368-1, 368-2, 368-3 formed below the first layer formed by the metasurface reconfigurable split rings 366-1, 366-2, 366-3 and a first dielectric layer 386. This enables operation of the refractory heaters 368-1, 368-2, 368-3 to pulse heat to the phase change material of the metasurface reconfigurable split rings 366-1, 366-2, 366-3. In order to maintain the active beam steering capabilities of each of the metasurface reconfigurable split rings 366-1, 366-2, 366-3, this gap in each metasurface reconfigurable split rings 366-1, 366-2, 366-3 may be bridged using a conductive bridge 384. The conductive bridge 384 allows for induced currents in each of the metasurface reconfigurable split rings 366-1, 366-2, 366-3 to create or adjust radiated fields that form the controllable reflected wave patterns described herein.

Below this first layer comprised of the metasurface reconfigurable split rings 366-1, 366-2, 366-3, the non-reconfigurable metal fixed ring 380, and the non-reconfigurable metal fixed center node 382, the reconfigurable metasurface unit cell 364 includes a first dielectric layer 386. This first dielectric layer 386 may be made of SiNx of AlN. In an embodiment, this first dielectric layer 386 may include any insulating substance that does not conduct electricity, but may also support electrostatic fields created during operation of the reconfigurable metasurface unit cell 364. Further, the first dielectric layer 386 may facilitate heat conduction between the refractory heaters 368-1, 368-2, 368-3 and the respective metasurface reconfigurable split rings 366-1, 366-2, 366-3.

Below the first dielectric layer 386, a second layer may be formed that comprises the first refractory heater 368-1, the second refractory heater 368-2, and the third refractory heater 368-3. The refractory heaters 368-1, 368-2, 368-3 may each, individually and selectively, heat their respective metasurface reconfigurable split ring 366-1, 366-2, 366-3 with high intensity short duration pulses of heat. Thus, when a power source is applied to the first refractory heater 368-1, the first refractory heater 368-1 heats the first metasurface reconfigurable split ring 366-1. Additionally, when the power source is applied to the second refractory heater 368-2, the second refractory heater 368-2 heats the second metasurface reconfigurable split ring 366-2. Further, when a power source is applied to the third refractory heater 368-3, the third refractory heater 368-3 heats the third metasurface reconfigurable split ring 366-3. Thus, the states of each of the metasurface reconfigurable split rings 366-1, 366-2, 366-3 may be individual controlled via pulse heating of the individual refractory heaters 368-1, 368-2, 368-3 such that the states of the metasurface reconfigurable split rings 366-1, 366-2, 366-3 may be switched from their amorphous states to their crystalline states or vice versa.

It is appreciated that the voltage and current applied to each of the refractory heaters 368-1, 368-2, 368-3 controls the states of the metasurface reconfigurable split rings 366-1, 366-2, 366-3. For example, where the voltage applied to any of the refractory heaters 368-1, 368-2, 368-3 is high (e.g., 15-20 V) for a short period of time (e.g., up to 0.5 microseconds (μs)) with a peak current of 300 to 310 mA, the metasurface reconfigurable split rings 366-1, 366-2, 366-3 are placed in an amorphous state. This application of this voltage at this current creates a peak temperature at a metasurface reconfigurable split ring 366-1, 366-2, 366-3 of 700 to 800° C. An average pulse power (W) may be initiated pulse heat to transition the phase change material the crystalline state at between 1Ω to 10Ω and to the amorphous state between 10⁵Ω to 10⁶Ω in order to transition from a conductive state to the dielectric state in this example. However, where the voltage applied to any of the refractory heaters 368-1, 368-2, 368-3 is relatively lower (e.g., 9-10 V) for a relatively longer period of time (e.g., 2 μs) with a peak current of 210 to 220 mA the metasurface reconfigurable split rings 366-1, 366-2, 366-3 are switched back to a crystalline state in an embodiment. This application of this voltage and current creates a peak temperature at a metasurface reconfigurable split ring 366-1, 366-2, 366-3 of 400 to 410° C. It is appreciated that heat pulses needed in order to place the non-volatile phase change material of the metasurface reconfigurable split rings 366-1, 366-2, 366-3 into an amorphous state or a crystalline state depends on the type of non-volatile phase change material used. Thus, the electrical pulse from the metasurface PMU (e.g., FIGS. 1, 172) at an applied voltage and current to each of the refractory heaters 368-1, 368-2, 368-3 to change the state of the non-volatile phase change material of each metasurface reconfigurable split ring 366-1, 366-2, 366-3 may depend on the type of non-volatile phase change material used. The present specification contemplates that any of a plurality of non-volatile phase change materials may be used necessitating changes in these applied voltages and currents.

Other layers and substrates may also be included in the stack within the reconfigurable metasurface unit cell 364. In an example embodiment, the reconfigurable metasurface unit cell 364 may further include an electrical dielectric substrate 388 placed below the second layer that comprises the refractory heaters 368-1, 368-2, 368-3. This electrical dielectric substrate 388 may be made of a HRSi, Al₂O₃, glass, or PCB among other dielectric materials. In an embodiment, the first dielectric layer 386 and electrical dielectric substrate 388 may electrically isolate the refractory heaters 368-1, 368-2, 368-3 from the remaining portions of the reconfigurable metasurface unit cell 364.

In an embodiment, a metallization layer 390 may be formed below the electrical dielectric substrate 388. This metallization layer 390 may be made of Au, Cu, Al, or Ni among other types of metals. In an embodiment, this metallization layer 390 may serve as an RF grounding source for the reconfigurable metasurface unit cell 364.

In an embodiment, a second dielectric layer 392 may be placed below the metallization layer 390. This second dielectric layer 392 may be made of silicon dioxide (SiO₂). Similar to the first dielectric layer 386, the second dielectric layer 392 may also support electrostatic fields created during the operation of the reconfigurable metasurface unit cell 364. In other embodiments, the second dielectric layer 392 may have limited thermal conductivity.

Below the second dielectric layer 392, the contact pads 370 used to electrically couple the refractory heaters 368-1, 368-2, 368-3 to a metasurface PMU (e.g., FIG. 1 172) is shown. The contact pads 370 may be made of any conductive metal such as Au, Cu, Al, or Ni among other types of metals. The contact pads 370 may receive those electrical pulses from the metasurface PMU in order to pulse heat, individually, each of the refractory heaters 368-1, 368-2, 368-3. In order to operatively couple each of the refractory heaters 368-1, 368-2, 368-3 to a respective contact pad 370, a plurality of metal interconnect layers 396 are formed. In the example embodiment shown in FIGS. 3A and 3B, the metal interconnect layers 396 couple a contact pad to each terminal end of each of the refractory heaters 368-1, 368-2, 368-3. In order to do so, one or more vias 394 are formed through, at least, the second dielectric layer 392, the metallization layer 390, and the electrical dielectric substrate 388 so that the metal interconnect layers 396 may pass from each of the respective contact pads 370 to their respective refractory heaters 368-1, 368-2, 368-3.

FIGS. 3A and 3B show a single reconfigurable metasurface unit cell 364 among a plurality of reconfigurable metasurface unit cells 364 that may form the reconfigurable metasurface unit cell array. It is appreciated that the reconfigurable metasurface unit cell array may comprise any number of individually activatable reconfigurable metasurface unit cells 364. In one example embodiment, the reconfigurable metasurface unit cell array may place the reconfigurable metasurface unit cells 364 in a row and column orientation thereby forming, for example, a sixteen-by-sixteen reconfigurable metasurface unit cell array. During operation, as described herein, each refractory heaters 368-1, 368-2, 368-3 are individually heated using the contact pads 370 such that each of the metasurface reconfigurable split rings 366-1, 366-2, 366-3, individually, undergo a phase change into an amorphous state or a crystalline state thereby changing the EM wave reflective properties of each individual unit cell 364 and allowing plural EM wave directions to be controlled with the reconfigurable metasurface unit cells 364 in the array. By selectively changing the individual EM wave reflective properties of each individual unit cell 364, the reconfigurable metasurface unit cell array may also change the directionality and feed distance of the reflected EM wave such that the reconfigurable metasurface unit cell array may direct the EM wave to a specific location and/or receiving device (e.g., FIGS. 1, 178). Because of the reflective directionality of the reconfigurable metasurface unit cell array may be changed readily (e.g., in the order of microseconds or nanoseconds), a single reconfigurable metasurface unit cell array may be reconfigured to relay data in radiofrequency signals via these EM waves to multiple receiving devices. Thus, in an environment where 5G or other EM waves are being relayed, the presently-described reconfigurable metasurface unit cell array may relay radiofrequency signal data around corners or along long distances in a radiofrequency environment in order to transmit that data to the appropriate receiving device.

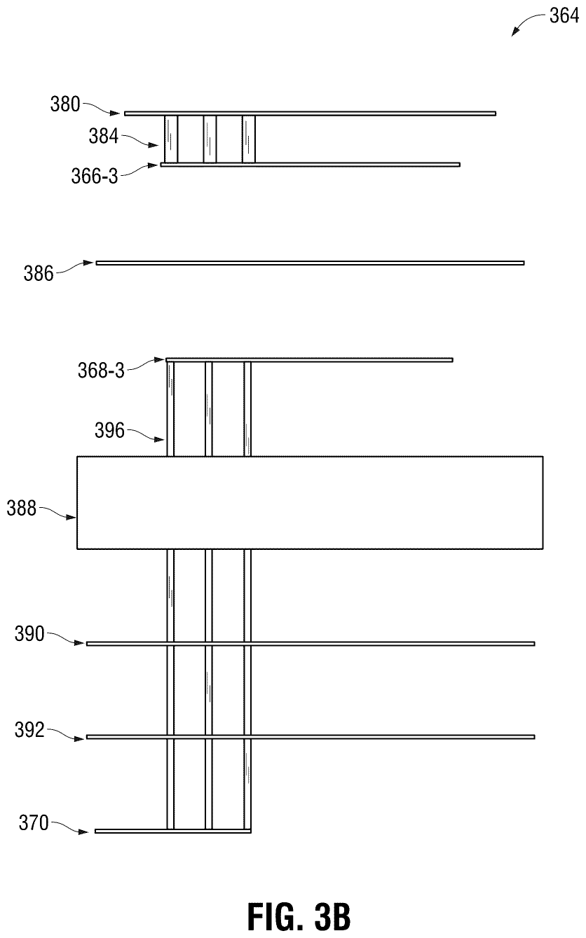

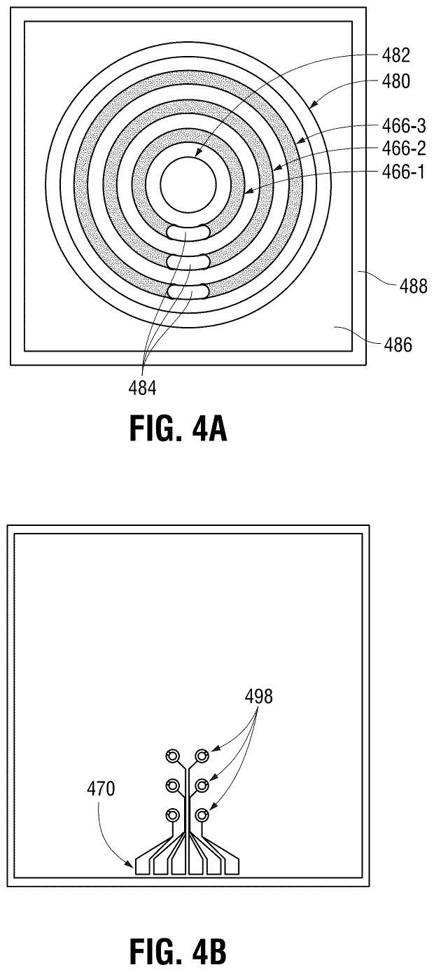

FIG. 4A is a top view graphic diagram showing a plurality of metasurface reconfigurable rings of a reconfigurable metasurface unit cell according to an embodiment of the present disclosure. Additionally, FIG. 4B is a top view diagram showing a plurality of contact pads of a reconfigurable metasurface unit cell according to an embodiment of the present disclosure. FIG. 4A shows the first dielectric layer 486 and electrical dielectric substrate 488 showing that these two layers reside below the first layer that comprises the first metasurface reconfigurable split ring 466-1, the second metasurface reconfigurable split ring 466-2, the third metasurface reconfigurable split ring 466-3, the non-reconfigurable metal fixed ring 480, and the non-reconfigurable metal fixed center node 482 of a reconfigurable metasurface unit cell (e.g., FIGS. 2A, 264). Although the non-reconfigurable metal fixed ring 480 is shown as an outer ring of the reconfigurable metasurface unit cell, it is contemplated that the reconfigurable metasurface unit cell may have the non-reconfigurable metal fixed ring 480 as any ring in the sequence of concentric plurality of metasurface reconfigurable rings 466-1, 466-2, 466-3 in various embodiments. Further, although a circular shape is shown for the plurality of metasurface reconfigurable rings 466-1, 466-2, 466-3 and the non-reconfigurable metal fixed ring 480, other concentric shapes are contemplated and may be implemented according to embodiments of the present disclosure including oval shapes, any geometric shapes, irregular shapes, or a mix of concentric shapes in various embodiments herein.

As described herein, each of these metasurface reconfigurable split rings 466-1, 466-2, 466-3 may include any phase change materials such as GeTe, SbTe, or GeSbTe among other similar non-volatile phase change materials. The metasurface reconfigurable split rings 466-1, 466-2, 466-3 share the same layer as the non-reconfigurable metal fixed ring 480 and non-reconfigurable metal fixed center node 482 and act together to focus the directionality of the EM wave beams reflected off of the reconfigurable metasurface unit cell array. In an embodiment, the non-reconfigurable metal fixed ring 480 and non-reconfigurable metal fixed center node 482 may be made of a metal such as gold (Au), copper (Cu), aluminum (Al), nickel (Ni) among other types of conductive metals.

In an embodiment, each of the metasurface reconfigurable split rings 466-1, 466-2, 466-3 may include a split or gap along the circumference of the metasurface reconfigurable split rings 466-1, 466-2, 466-3. As shown in FIG. 3A, for example, this gap correlates with a gap in each of the respective refractory heaters (e.g., FIG. 3A, 368-1, 368-2, 368-3) formed below the first layer formed by the metasurface reconfigurable split rings 466-1, 466-2, 466-3 and a first dielectric layer 486. In order to complete the ring or other shaped structure each of the metasurface reconfigurable split rings 466-1, 466-2, 466-3, this gap in each metasurface reconfigurable split rings 466-1, 466-2, 466-3 may be bridged using its own conductive bridge 484. The conductive bridges 484 allow for induced currents in each of the metasurface reconfigurable split rings 466-1, 466-2, 466-3 to create radiated fields that form the reflected wave patterns and control of directionality of those radiofrequency signals as described herein.

It is appreciated that each of the terminal ends of each refractory heater structure corresponding to each of the metasurface reconfigurable rings 466-1, 466-2, 466-3 may be operatively coupled to a contact pad 470 via one or more contact pad leads 498 as shown in FIG. 4B. The contact pad leads 498 may be placed directly below each terminal end of each refractory heater structure corresponding to each of metasurface reconfigurable ring 466-1, 466-2, 466-3 such that the vias may be formed through the various layers of the reconfigurable metasurface unit cell with the metal interconnect layers (e.g., FIGS. 3A, 396) operatively coupling each contact pad lead 498 to their respective terminal end of each refractory heater structure corresponding to each metasurface reconfigurable ring 466-1, 466-2, 466-3. FIG. 4B also shows an example arrangement of each of the contact pads 470 and contact pad leads 498 such that a metasurface PMU may provide the necessary electrical pulses to each refractory heater structure corresponding to each of the metasurface reconfigurable rings 466-1, 466-2, 466-3 as described herein.

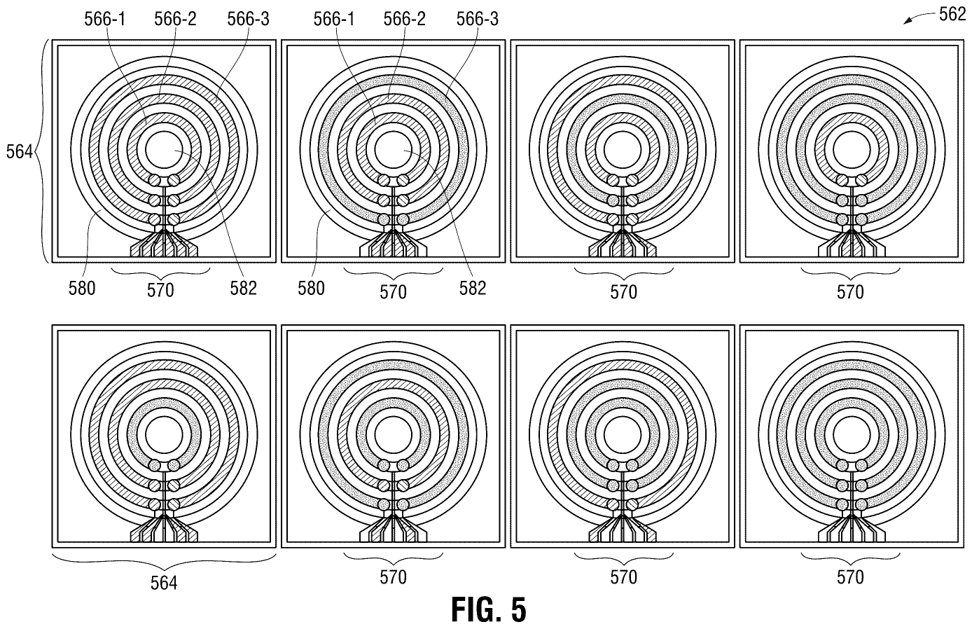

FIG. 5 is a top view of a plurality of reconfigurable metasurface unit cells of a reconfigurable metasurface unit cell array depicting various activation states of the plurality of reconfigurable metasurface unit cells according to an embodiment of the present disclosure. It is appreciated that although FIG. 5 shows a reconfigurable metasurface unit cell array 562 having a four by two unit cell 564 arrangement, this may represent only a portion of a reconfigurable metasurface unit cell array 562. The present specification contemplates that the reconfigurable metasurface unit cell array 562 may include more or fewer unit cells 564 than those shown in FIG. 5. In an embodiment, the reconfigurable metasurface unit cell array 562 may be an array of sixteen unit cells 564 by sixteen reconfigurable metasurface unit cells 564. It is also appreciated that although for purposes of description, FIG. 5 is described with respect to the various elements of the reconfigurable metasurface unit cells 564 in the top-left two unit cells 564, the other reconfigurable metasurface unit cells 564 depicted in FIG. 5 include similar elements and operation as described in FIG. 5.

Again, each reconfigurable metasurface unit cell 564 may include a first metasurface reconfigurable split ring 566-1, a second metasurface reconfigurable split ring 566-2, and a third metasurface reconfigurable split ring 566-3. Each of these metasurface reconfigurable split rings 366-1, 366-2, 366-3 may include any phase change materials such as GeTe, SbTe, or GeSbTe among other similar non-volatile phase change materials. The metasurface reconfigurable split rings 366-1, 366-2, 366-3 share the same layer as the non-reconfigurable metal fixed ring 380 and non-reconfigurable metal fixed center node 382 and act together to focus the directionality of the EM wave beams reflected off of the reconfigurable metasurface unit cell array according to embodiments herein. In an embodiment, the non-reconfigurable metal fixed ring 380 and non-reconfigurable metal fixed center node 382 may be made of a metal such as Au, Cu, Al, Ni among other types of conductive metals.

As shown in FIG. 5, the top left unit cell 564 shows that all three of the metasurface reconfigurable rings 566-1, 566-2, 566-3 have been placed in an amorphous state. This is indicated by the hash fill of these elements indicating, in this example embodiment, that these metasurface reconfigurable rings 566-1, 566-2, 566-3 have been placed in the amorphous state and are non-conductive. Again, these states in each of the metasurface reconfigurable rings 566-1, 566-2, 566-3 are achieved and individually controlled via pulse heating of the individual refractory heaters (not shown) such that the states of the metasurface reconfigurable rings 566-1, 566-2, 566-3 may be switched from their amorphous states to their crystalline states or vice versa.

FIG. 5 shows that a neighboring reconfigurable metasurface unit cell 564 to the immediate right of the left-most upper unit cell 564 has two of the metasurface reconfigurable rings 566-1 and 566-2 that have been placed in the amorphous state while another metasurface reconfigurable ring 566-3 has been placed in the crystalline state. In this example, the first metasurface reconfigurable split ring 566-1 and second metasurface reconfigurable split ring 566-2 have been placed in the amorphous state indicated by the hash fill and which is non-conductive while the third metasurface reconfigurable split ring 566-3 has been placed in the crystalline state which is conductive as indicated by the dotted fill for this element. Again, it is appreciated that the pulse of voltage and current applied to each of the refractory heaters controls the states of the metasurface reconfigurable rings 566-1, 566-2, 566-3. For example, where the voltage applied to any of the refractory heaters is high (e.g., 15-20 V) for a short period of time (e.g., up to 0.5 μs) with a peak current of 300 to 310 mA, the metasurface reconfigurable rings 566-1, 566-2, 566-3 are placed in an amorphous state as shown in the first metasurface reconfigurable split ring 566-1 and second metasurface reconfigurable split ring 566-2. The application of this voltage at this current creates a peak temperature at the first metasurface reconfigurable split ring 566-1 and second metasurface reconfigurable split ring 566-2 of 700 to 800° C. in order to transition from the crystalline state to this amorphous state in this example. Such a heat pulse may change the first metasurface reconfigurable split ring 566-1 and the second metasurface reconfigurable split ring 566-2 as described.

However, where the voltage applied to any of the refractory heaters is relatively lower (e.g., 9-10 V) for a relatively longer period of time (e.g., 2 μs) with a peak current of 210 to 220 mA the metasurface reconfigurable split rings 566-1, 566-2, 566-3 are placed in a crystalline state such as that shown in the third metasurface reconfigurable split ring 566-3. This application of this voltage at this current creates a peak temperature at the third metasurface reconfigurable split ring 566-3 of 400 to 410° C. in order to transition from the amorphous state to this crystalline state in a second example as may be shown in the difference of activated metasurface reconfigurable rings 566-1, 566-2 between the two top row neighboring reconfigurable metasurface unit cells 564. It is appreciated that in order to place the non-volatile phase change material of the metasurface reconfigurable rings 566-1, 566-2, 566-3 into an amorphous state or a crystalline state depends on the type of non-volatile phase change material used. Thus, the electrical pulse from the metasurface PMU (e.g., FIGS. 1, 172) at an applied voltage and current to each of the refractory heaters to change the state of the non-volatile phase change material of each metasurface reconfigurable rings 566-1, 566-2, 566-3 may depend on the type of non-volatile phase change material used and the present specification contemplates that other non-volatile phase change materials may be used necessitating changes in these applied voltages and currents.

Because each of the individual reconfigurable metasurface unit cells 564 shown in FIG. 5 may be individually tuned such that each of the individual metasurface reconfigurable rings 566-1, 566-2, 566-3 can be changed from an amorphous state to a crystalline state or vice versa, the EM wave reflection properties of the reconfigurable metasurface unit cell array 562 may be changed in each reconfigurable metasurface unit cell 564 and across the reconfigurable metasurface unit cell array to direct or focus receipt or reflection of radiofrequency signals between a source wireless information handling system and a target wireless information handling system. In an embodiment, the amorphous state or crystalline state of some metasurface reconfigurable rings 566-1, 566-2, 566-3 may be changed such that each individual unit cell 564 may engage in constructive or destructive interference. This constructive or destructive interference may contribute, as whole, to the beam forming capabilities of the reconfigurable metasurface unit cell array 562 thereby allowing for an increase or decrease in feed distance of the reflected EM waves, and or higher or lower power distribution plane distance across the surface of the reconfigurable metasurface unit cell array 562 in order to adjust directionality lobes of EM wave reflection and distribution of radiofrequency signals between source and target wireless devices in a radiofrequency environment.

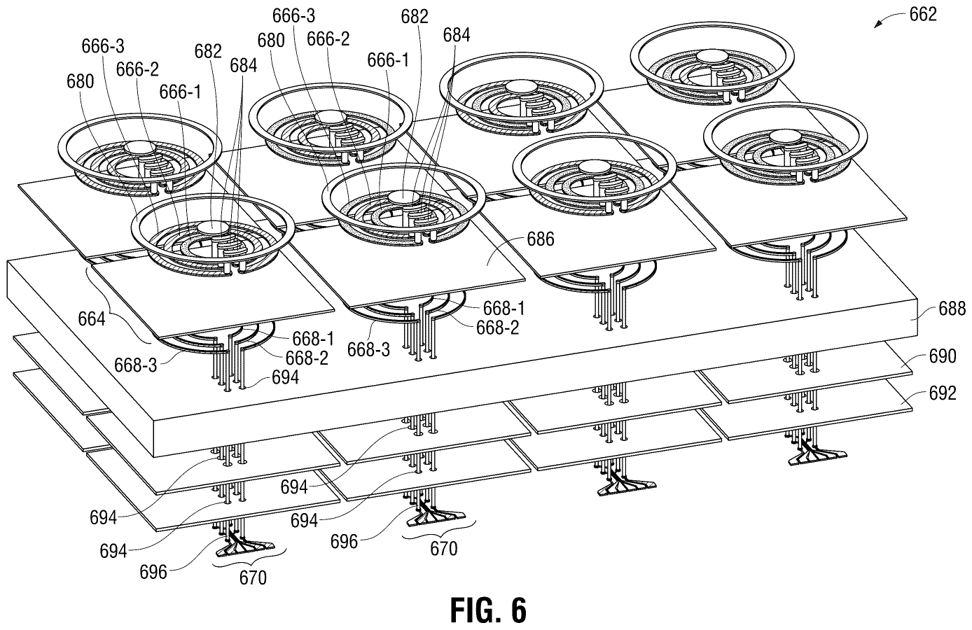

FIG. 6 is a graphic diagram showing an exploded perspective view of the reconfigurable metasurface unit cell array according to an embodiment of the present disclosure. In this example, FIG. 6 is a perspective view exploded graphic diagram illustrating a plurality of unit cells 664 of a reconfigurable metasurface unit cell array 662 according to another embodiment of the present disclosure. As shown in FIG. 6, each reconfigurable metasurface unit cell 664 may include a staking of various elements similar to those presented in FIG. 3A for example. It is appreciated that each of the reconfigurable metasurface unit cells 664 of the reconfigurable metasurface unit cell array 662 may comprise their own various layers or may, in an embodiment, share the same layer or layers within the array. Again, the reconfigurable metasurface unit cell 664 shown in FIG. 6 may one of a plurality of unit cells 664 that form the reconfigurable metasurface unit cell array 662 and may include any number of unit cells 664 arranged in any manner on a two-dimensional plane. In an embodiment, the reconfigurable metasurface unit cell array 662 may be an array of sixteen unit cells 664 by sixteen unit cells 664. It is also appreciated that although FIG. 6 shows the various elements of the plurality of reconfigurable metasurface unit cells 664, for purposes of discussion the bottom-left two reconfigurable metasurface unit cells 664 are discussed, however, the other unit cells 664 depicted in FIG. 6 include similar elements and operation as described in FIG. 6.

As shown in FIG. 6, the reconfigurable metasurface unit cells 664 include concentrically formed first metasurface reconfigurable split ring 666-1, second metasurface reconfigurable split ring 666-2, and third metasurface reconfigurable split ring 666-3 on a first layer of the reconfigurable metasurface unit cell 664. Each of these metasurface reconfigurable split rings 666-1, 666-2, 666-3 may include any phase change materials such as GeTe, SbTe, or GeSbTe among other similar non-volatile phase change materials. The metasurface reconfigurable split rings 666-1, 666-2, 666-3 share the same layer as the non-reconfigurable metal fixed ring 680 and non-reconfigurable metal fixed center node 682 and act together to focus (e.g., increase or decrease the feed distance) the directionality (e.g., beam steering) of the EM wave beams reflected off of the reconfigurable metasurface unit cell array 662 as described in embodiments herein. In an embodiment, the non-reconfigurable metal fixed ring 680 and non-reconfigurable metal fixed center node 682 may be made of a metal such as Au, Cu, Al, Ni among other types of conductive metals. It is appreciated that the metasurface reconfigurable rings 666-1, 666-2, 666-3, the non-reconfigurable metal fixed ring 680, and the non-reconfigurable metal fixed center node 682 may be formed onto the same layer and may be referred to herein as a first layer of any given unit cell 664.

In an embodiment, each of the metasurface reconfigurable split rings 666-1, 666-2, 666-3 may include a split or gap along the circumference of the metasurface reconfigurable split rings 666-1, 666-2, 666-3. As shown in FIG. 6, for example, this gap correlates with a gap in each of the respective refractory heaters 668-1, 668-2, 668-3 formed below the first layer so the refractory 668-1, 668-2, 668-3 may operate. In order, however, to complete a conductive ring structure when phase change material is in a conductive state of each of the metasurface reconfigurable split rings 666-1, 666-2, 666-3, this gap in each metasurface reconfigurable split rings 666-1, 666-2, 666-3 may be bridged using a conductive bridge 684. The conductive bridge 684 allows for induced currents in each of the metasurface reconfigurable split rings 666-1, 666-2, 666-3 to create radiated fields that form the reflected wave patterns described in embodiments herein.

Below this first layer comprised of the metasurface reconfigurable split rings 666-1, 666-2, 666-3, the non-reconfigurable metal fixed ring 680, and the non-reconfigurable metal fixed center node 682, the reconfigurable metasurface unit cell 664 includes a first dielectric layer 686. This first dielectric layer 686 may be made of SiNx of AlN. In an embodiment, this first dielectric layer 686 may include any insulating substance that does not conduct electricity, but may also support electrostatic fields created during operation of the reconfigurable metasurface unit cell 664. This first dielectric layer 686 may still be thermally conductive however in embodiments herein. In an embodiment, the first dielectric layer 686 may be shared among all unit cells 664 within the reconfigurable metasurface unit cell array 662. In another embodiment shown in FIG. 6, each reconfigurable metasurface unit cell 664 has its own dedicated first dielectric layer 686.

Below the first dielectric layer 686, a second layer may be formed that comprise the first refractory heater 668-1, the second refractory heater 668-2, and the third refractory heater 668-3. The refractory heaters 668-1, 668-2, 668-3 may each, individually and selectively, heat their respective metasurface reconfigurable split ring 666-1, 666-2, 666-3. Thus, when a power source is applied to the first refractory heater 668-1, the first refractory heater 668-1 heats the first metasurface reconfigurable split ring 666-1. Additionally, when the power source is applied to the second refractory heater 668-2, the second refractory heater 668-2 heats the second metasurface reconfigurable split ring 666-2. Further, when a power source is applied to the third refractory heater 668-3, the third refractory heater 668-3 heats the third metasurface reconfigurable split ring 666-3. Thus, the states of each of the metasurface reconfigurable split rings 666-1, 666-2, 666-3 may be individual controlled via heating of the individual refractory heaters 668-1, 668-2, 668-3 such that the states of the metasurface reconfigurable split rings 666-1, 666-2, 666-3 may be switched from their amorphous states to their crystalline states or vice versa. It is appreciated that the number of refractory heaters 668-1, 668-2, 668-3 shown in FIG. 6 is merely an example number of refractory heaters 668-1, 668-2, 668-3 and where the number of metasurface reconfigurable rings 666-1, 666-2, 666-3 increases beyond the three shown, a commensurate number of refractory heaters 668-1, 668-2, 668-3 may also be added to accommodate for the extra number of metasurface reconfigurable rings 666-1, 666-2, 666-3. Additionally, where the number of refractory heaters 668-1, 668-2, 668-3 increases beyond the three shown in FIG. 6, a commensurate number of contact pads 670, metal interconnect layers 696, and vias 694 are also increased to accommodate for the application of the power pulses to the additional refractory heaters 668-1, 668-2, 668-3.

It is appreciated that the voltage and current applied to each of the refractory heaters 668-1, 668-2, 668-3 controls the states of the metasurface reconfigurable split rings 666-1, 666-2, 666-3. For example, where the voltage applied to any of the refractory heaters 668-1, 668-2, 668-3 is high (e.g., 15-20 V) for a short period of time (e.g., up to 0.5 microseconds (μs)) with a peak current of 300 to 310 mA, the metasurface reconfigurable split rings 666-1, 666-2, 666-3 are transitioned to an amorphous state. This application of this voltage at this current creates a peak temperature at a metasurface reconfigurable split ring 666-1, 666-2, 666-3 of 700 to 800° C. in order to transition from the crystalline state to this amorphous state in this example. However, where the voltage applied to any of the refractory heaters 668-1, 668-2, 668-3 is relatively lower (e.g., 9-10 V) for a relatively longer period of time (e.g., 2 μs) with a peak current of 210 to 220 mA the metasurface reconfigurable split rings 666-1, 666-2, 666-3 are transitioned to a crystalline state. This application of this voltage at this current creates a peak temperature at a metasurface reconfigurable split ring 666-1, 666-2, 666-3 of 400 to 410° C. in order to transition from the amorphous state to this crystalline state in this example. It is appreciated that in order to place the non-volatile phase change material of the metasurface reconfigurable split rings 666-1, 666-2, 666-3 into an amorphous state or a crystalline state depends on the type of non-volatile phase change material used. Thus, the electrical pulse from the metasurface PMU (e.g., FIGS. 1, 172) at an applied voltage and current to each of the refractory heaters 668-1, 668-2, 668-3 to change the state of the non-volatile phase change material of each metasurface reconfigurable split ring 666-1, 666-2, 666-3 may depend on the type of non-volatile phase change material used and the present specification contemplates that other non-volatile phase change materials may be used necessitating changes in these applied voltages and currents.

Other layers and substrates may also be included in the stack within the reconfigurable metasurface unit cell 664. In an example embodiment, the reconfigurable metasurface unit cell 664 may further include an electrical dielectric substrate 688 placed below the second layer that comprises the refractory heaters 668-1, 668-2, 668-3. This electrical dielectric substrate 688 may be made of a HRSi, Al₂O₃, glass, or PCB among other dielectric materials. In an embodiment, the first dielectric layer 686 and electrical dielectric substrate 688 may electrically isolate the refractory heaters 668-1, 668-2, 668-3 from the remaining portions of the reconfigurable metasurface unit cell 664. Again, it is appreciated that each of the reconfigurable metasurface unit cells 664 of the reconfigurable metasurface unit cell array 662 may share the same layer of electrical dielectric substrate 688 as shown in FIG. 6. However, the present specification also contemplates that each reconfigurable metasurface unit cell 664 may have their own layer of electrical dielectric substrate 688 disconnected from the electrical dielectric substrates 688 of the other unit cells 664.

In an embodiment, a metallization layer 690 may be formed below the electrical dielectric substrate 688. This metallization layer 690 may be made of Au, Cu, Al, or Ni among other types of metals. In an embodiment, this metallization layer 690 may serve as an RF grounding source for the reconfigurable metasurface unit cell 664. Again, it is appreciated that each of the reconfigurable metasurface unit cells 664 of the reconfigurable metasurface unit cell array 662 may share the same layer of metallization layer 690. However, the present specification also contemplates that each reconfigurable metasurface unit cell 664 may have their own layer of metallization layer 690 disconnected from the metallization layer 690 of the other unit cells 664 as shown in FIG. 6.

In an embodiment, a second dielectric layer 692 may be placed below the metallization layer 690. This second dielectric layer 692 may be made of silicon dioxide (SiO₂). Similar to the first dielectric layer 686, the second dielectric layer 692 may also support electrostatic fields created during the operation of the reconfigurable metasurface unit cell 664. Again, it is appreciated that each of the reconfigurable metasurface unit cells 664 of the reconfigurable metasurface unit cell array 662 may share the same layer of second dielectric layer 692. However, the present specification also contemplates that each unit cell 664 may have their own layer of second dielectric layer 692 disconnected from the second dielectric layers 692 of the other unit cells 664 as shown in FIG. 6.

Below the second dielectric layer 692, the contact pads 670 used to electrically couple the refractory heaters 668-1, 668-2, 668-3 to a metasurface PMU (e.g., FIG. 1 172) are shown. The contact pads 670 may be made of any conductive metal such as Au, Cu, Al, or Ni among other types of metals. The contact pads 670 may receive those electrical pulses from the metasurface PMU in order to heat, individually, each of the refractory heaters 668-1, 668-2, 668-3. In order to operatively couple each of the refractory heaters 668-1, 668-2, 668-3 to a respective contact pad 670, a plurality of metal interconnect layers 696 are formed. In the example embodiment shown in FIG. 6, the metal interconnect layers 696 couple a contact pad to each terminal end of each of the refractory heaters 668-1, 668-2, 668-3. In order to do so, one or more vias 694 are formed through, at least, the second dielectric layer 692, the metallization layer 690, and the electrical dielectric substrate 688 so that the metal interconnect layers 696 may pass from each of the respective contact pads 670 to their respective refractory heaters 668-1, 668-2, 668-3.

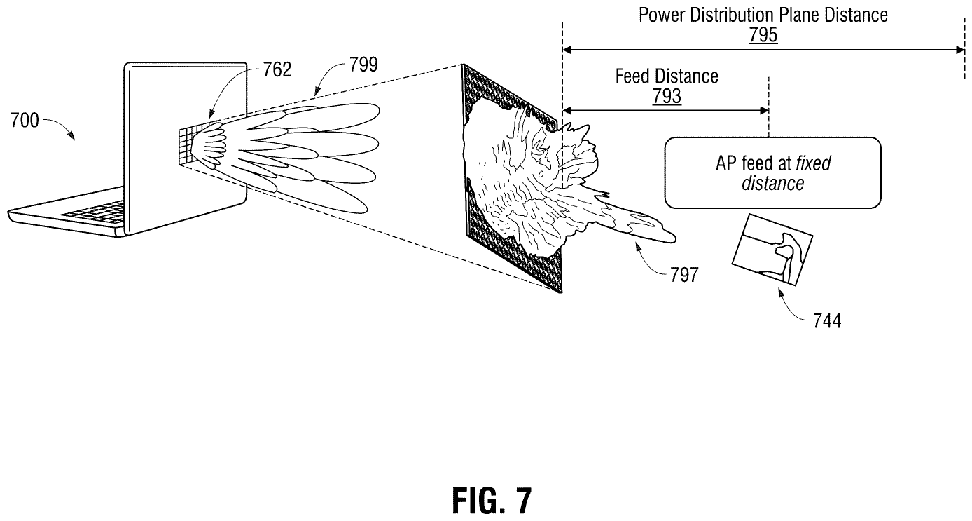

FIG. 7 is graphic diagram of a reconfigurable metasurface unit cell array and its electromagnetic wave reflection properties according to an embodiment of the present disclosure. It is appreciated that this reconfigurable metasurface unit cell array 762 may be placed on any surface such as an a-cover or top cover of the laptop-type information handling system 700 described in the example embodiment herein or located on any surface within an radiofrequency environment such as an office, home, or other space. In an embodiment, the reconfigurable metasurface unit cell array 762 may be a 28 GHz mmWave reconfigurable metasurface unit cell array 762 that is used to reflect incoming EM waves off of the surface of the information handling system 700 thereby treating the information handling system 700 as a relay of EM waves within any radiofrequency environment such as an office environment.

FIG. 7 also shows that the resulting EM wave reflection pattern 799 is shown in larger detail. This EM wave reflection pattern 799 include a focused beam that has a specific directionality. As described in embodiments herein, the configuration of the metasurface reconfigurable rings via actuation of the refractory heaters causes each individual metasurface reconfigurable ring to change from an amorphous state to a crystalline state or vice versa to adjust directionality of each reconfigurable metasurface unit cell within the reconfigurable metasurface unit cell array 762. The configuration of each of these metasurface reconfigurable rings within each of the reconfigurable metasurface unit cells of the reconfigurable metasurface unit cell array 762 causes each unit cell to engage in destructive or constructive interference, between concentric rings as well as between the plurality of reconfigurable metasurface unit cells, in order to create a focused beam 797 within the EM wave reflection pattern 799. As shown in FIG. 7, this focused beam 797 is directed towards an AP at a known or detected location 744 in the radiofrequency environment. The feed distance 793 of this focused beam 797 may be sufficient to extend the reflected EM wave to the AP at location 744 so that radiofrequency signal data may be efficiently transferred from a transmitting device (not shown), reflected off of the reconfigurable metasurface unit cell array 762, and received by the AP at location 744 according to embodiments herein. In other embodiments, location 744 may be the location of a target receiver wireless device (such as 178 of FIG. 1) and the focused beam 797 is directed towards an target receiver wireless device at location 744 that is a known or detected location or to a low radiofrequency throughput location within a radiofrequency environment according to embodiments herein. The feed distance 793 of this focused beam 797 may be sufficient to extend the reflected EM wave to the location 744 of the target receiver wireless device (e.g., 178) or the low radiofrequency throughput location of a radiofrequency environment so that radiofrequency signal data may be efficiently transferred from a transmitting device such as an AP, reflected off of the reconfigurable metasurface unit cell array 762, and received by the target receiver wireless device (e.g., 178) or the low radiofrequency throughput location of a radiofrequency environment according to embodiments herein.

FIG. 7 also shows a power distribution plane distance 795. This power distribution plane distance 795 may describe the distance from the reconfigurable metasurface unit cell array 762 where the reflected EM waves reach a relatively uniform power distribution across its plane. This means that the wavefront is considered to be a far field region several wavelengths away from the reconfigurable metasurface unit cell array 762.

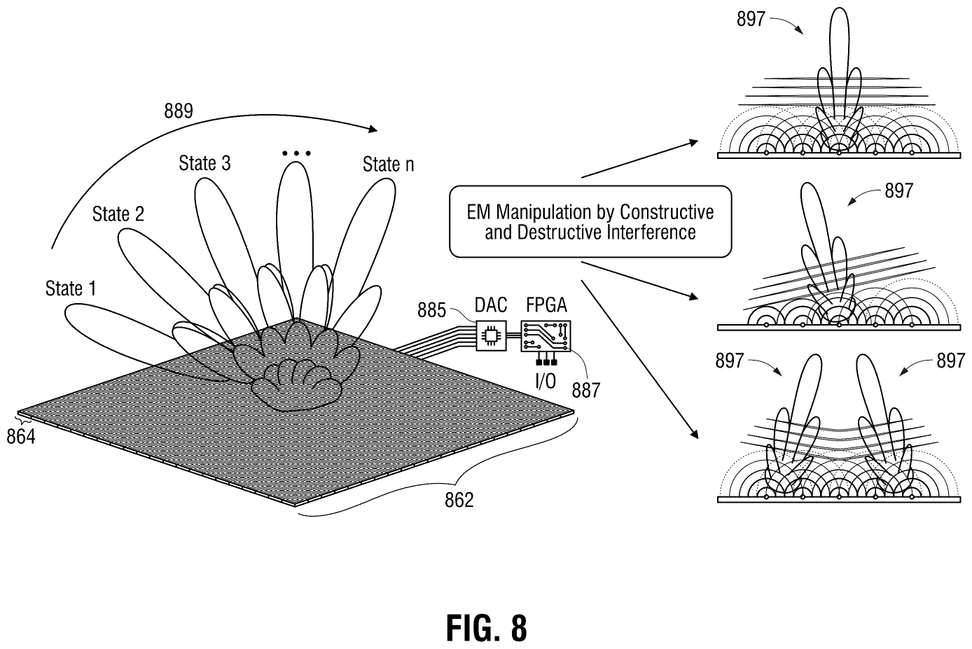

FIG. 8 is a graphic diagram of various emission states of a reconfigurable metasurface unit cell array 862 operated by a digital-to-analog converter (DAC) 893 and a field programmable gate array (FPGA) 891 operating as a metasurface controller according to an embodiment of the present disclosure. The DAC 893 and a metasurface controller such as an FPGA 891 may be formed on a printed circuit board with a power source or PMU and operatively coupled to the reconfigurable metasurface unit cell array 862. This DAC 893, metasurface controller such as an FPGA 891, and power source may be operatively coupled to contact pads of the reconfigurable metasurface unit cells of the reconfigurable metasurface unit cell array 862 in embodiments herein. FIG. 8 shows an example of the reconfigurable metasurface unit cell array 862 comprising an array of sixteen-by-sixteen reconfigurable metasurface unit cells that cooperate to direct and beamform a reflected EM wave.

As described herein, the each of the reconfigurable metasurface unit cells 864 may be controlled via use of a metasurface controller such as FPGA 787 that controls power provided from a power source, such as PMU with battery or A/C power source, to each of the refractory heaters in order to change the metasurface reconfigurable split rings from amorphous state to a crystalline state or vice versa. In the embodiment shown in FIG. 8, the metasurface PMU or PMU associated with the information handling system may provide power to the DAC 893 and an FPGA 887 that selectively applies the electrical pulses of power to each individual metasurface reconfigurable split ring of each unit cell within the reconfigurable metasurface unit cell array 862. The FPGA 887 may be any integrated circuit that contains the digital logic to actuate each refractory heater by control of power from a power source or PMU such that the state of each metasurface reconfigurable split ring can be changed between an amorphous to a crystalline state or vice versa in order to create a transmission state and direction of the reflected EM waves off of the surface of the reconfigurable metasurface unit cell array 862. In an embodiment, a look-up table may be made accessible by the FPGA 887 the describes how the FPGA 887 is to activate each of the refractory heaters in order to create destructive or constructive interference from each of the reconfigurable metasurface unit cells 864 thereby creating the directionality and feed distance necessary to reflect the EM waves towards a receiving device in focused beams 897. Again, this transmission state and direction of the reflected EM waves off of the surface of the metasurface may include the use of constructive and destructive interference to create a focused beam 797 in any of a plurality of specific directions 789. As shown in FIG. 8, a direction 889 of the reflected EM waves may be controlled using phase shifting properties to change the direction 889 of the focused beam 897 or multiple focused beams 897 as shown by the individual states (e.g., “State 1,” “State 2,” “State 3,” and “State n”).

During operation, the output from the FPGA 887 or other metasurface controller may be passed through the DAC 885. The DAC 885 may convert any digital signal from the FPGA 887 into an analog signal so that the correct electrical pulse from a power source can be transmitted to a refractory heater in order to change the state of a correlated metasurface reconfigurable split ring so as to create the focused beam 897 described herein. By switching each of the metasurface reconfigurable split rings of each reconfigurable metasurface unit cells 864 of the reconfigurable metasurface unit cell array 862 between the amorphous state and the crystalline state, the reconfigurable metasurface unit cell array 862 may be configured to redirect transmitted EM waves and beam steer those EM waves in a desired direction 889. Additionally, because the heating of the phase change material of the metasurface reconfigurable split rings of the reconfigurable metasurface unit cells 864 can be achieved by applying thermal energy such as a pulse of heat with a certain amplitude and width (on the order of nanoseconds) through electrically insulated high-speed heaters, the constant application of power is not needed thereby reducing the need for a dedicated power source. Indeed, in some embodiments, these phase change materials of the metasurface reconfigurable split rings hold their crystalline or amorphous states as long as it is not actuated with another pulse of heat. This allows for the reconfigurable metasurface unit cell array 862 to change, within short periods of time, the directionality of the focused beam 897 or beams 897 among a plurality of directions 889 such that data may be transmitted from a variety of locations, relay by and reflected off of the surface of the reconfigurable metasurface unit cell array 862, and towards a variety of locations. This allows for data from these locationally distinct transmitting devices to be transmitted to locationally distinct receiving devices using the reconfigurable metasurface unit cell array 862 as an EM wave reflective surface.

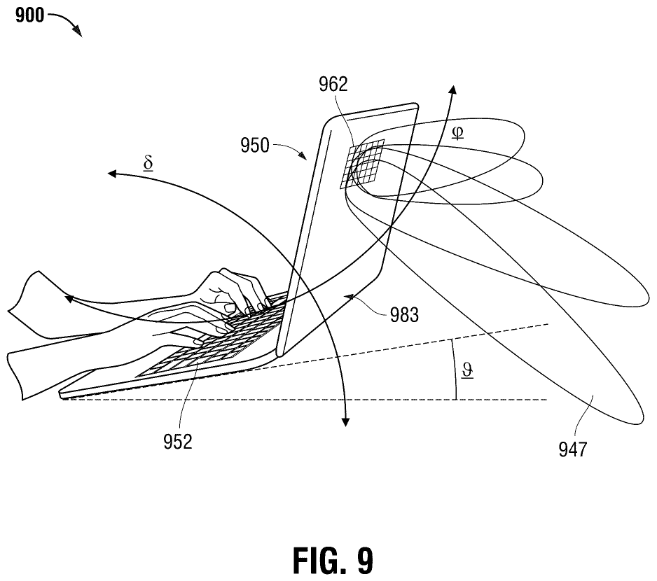

FIG. 9 is a graphic diagram illustrating a resulting angle of a radiofrequency beam 947 emitted from the non-volatile reconfigurable metasurface unit cell array as the position of the information handling system is changed relative to a receiving device or a low throughput zone and a radiofrequency source device, which may be the information handling system, within a radiofrequency environment according to an embodiment of the present disclosure.

As described herein, the metasurface adaptive wireless beamforming system module (not shown) executed by a hardware processor of the information handling system 900 may accommodate for changes in the position of the information handling system 900 and a non-volatile reconfigurable metasurface unit cell array 962 coupled thereto. These changes may result from the metasurface adaptive wireless beamforming system module detecting that the information handling system 900 has been moved and that the movement is determined to meet or exceed a movement threshold over a period of time (e.g., at or above 0.25 inches of movement and movement of the information handling system for 2 seconds or more). Such movement will effect a radiofrequency beam 947 emitted or reflected from the non-volatile reconfigurable metasurface unit cell array 962 and may trigger a radiofrequency throughput scan for RSSI levels to determine if radiofrequency beam 947 still aligns with a location of a receiver wireless device or a low throughput zone in a radiofrequency environment of the information handling system 900.

For example, if the base of the information handling system is angled (e.g., ϑ) up or down, that movement of the EM wave beam 947 up or down may prevent the reconfigurable metasurface unit cell array 962 from properly directing the EM wave beam 947 towards another information handling system or towards the low throughput zone. Similarly, by changing the degree of the lid portion of the information handling system (e.g., the A-cover 983) relative to the base portion (e.g., δ), that movement of the EM wave beam 947 up or down may prevent the reconfigurable metasurface unit cell array 962 from properly directing the EM wave beam 947 towards another information handling system or towards the low throughput zone. Still further, movement of the information handling system clockwise or counterclockwise by a certain degree (e.g., φ) will also change a lateral direction of the EM wave beam 947 thereby also preventing the reconfigurable metasurface unit cell array 962 from properly directing the EM wave beam 947 towards another wireless information handling system or towards the low throughput zone. As described herein, this movement of the information handling system in any of these directions or a combination thereof as detected by a motion sensor, such as an onboard accelerometer or other motion sensor device on the information handling system 900, may initiate a radiofrequency throughput scan for RSSI levels. If movement has adjusted the radiofrequency beam 947 out of alignment with another wireless information handling system or away from a low throughput zone, a reconfiguration of the EM wave beam 947 via the metasurface adaptive wireless beamforming system module may occur as described herein.

Depending on the data received from the motion sensors such as the accelerometer including movement amount and the total detected duration of the movement, the reconfiguration of the EM wave beam 947 reflected from the reconfigurable metasurface unit cell array 962 may be triggered such that the EM wave beam 947 may be redirected towards a low throughput zone within an environment the information handling system is present or towards another information handling system. The movement detected may be required to be above movement thresholds for data received from the motion sensors such as the accelerometer including movement amount and the total detected duration of the movement such that bumps, vibrations, or small movements of the information handling system 900 do not trigger a radiofrequency throughput scan for RSSI levels and then, potentially, a reconfiguration of one or more reconfigurable metasurface unit cells of the reconfigurable metasurface unit cell array 962.

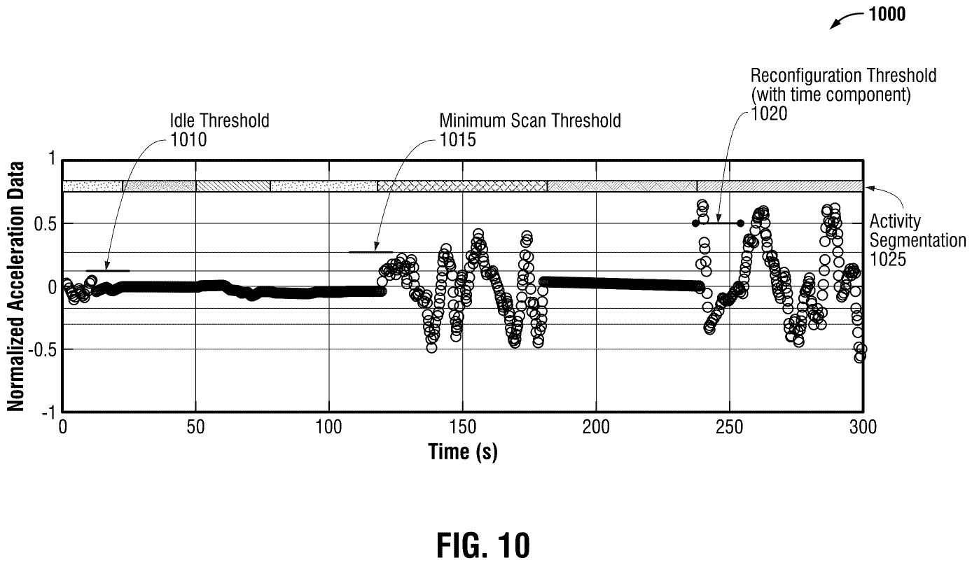

FIG. 10 is a graph depicting one or more detected motion thresholds that can be used to determine if and when a reflected electromagnetic (EM) wave of the reconfigurable metasurface unit cell array is to be scanned and may be reconfigured to beamform towards a receiving device or a low throughput zone within a radiofrequency environment according to an embodiment of the present disclosure. The graph 100 depicts a normalized acceleration data x-axis and a time y-axis with a series of plotted movement points of an information handling system as detected by an accelerometer or other motion or position detection sensor device on the information handling system. In an embodiment, one or more activity segments may be defined via an activity segmentation 1025 in the graph and used by the metasurface adaptive wireless beamforming system module. The activity segments 1025 depict those portions of time where activity or inactivity has been detected via one or more of the motion sensor devices, such as an accelerometer. Some activity may be continuous in the background such as vibration or small motions. Other activity may represent substantial movement of the information handling system such as a substantial movement amount detected or how long a movement occurs. This activity may include the user opening the lid of the information handling system, using the trackpad, typing on the keyboard, or fully positioning or repositioning the information handling system, among other detected movements by the user.

The graph 1000 shows an idle threshold 1010. The idle threshold 1010 may be set to a specific level of detectable and normalized acceleration (e.g., movement and change of velocity of information handling system over time) such that, so long as the plotted movement points do not exceed a positive or negative rate of change of velocity over time, no radiofrequency throughput scan for RSSI levels is triggered and power consumption may be minimized. This idle threshold will not trigger any RSSI scan by, for example, a wireless interface adapter and radio of the information handling system or any radiofrequency sensor or radio system operably coupled to the reconfigurable metasurface or antennas locate thereon. This RSSI scan may include any process in which the information handling system measures the strength of radio signals received from wireless transmitters via plural space antennas or reconfigurable metasurface unit cells and determines locations within the radio frequency environment where such radiofrequency signals are not received relative to detected source locations of radiofrequency signals. Those locations within the environment where RSSI signals are not received may indicate a low throughput zone within the radiofrequency environment and may be used later to redirect the EM wave beam towards that area in some embodiments herein.

The graph 1000 also shows a minimum scan threshold 1015. This minimum scan threshold 1015 may be the normalized acceleration threshold value at which an RSSI scan is initiated. In an embodiment, if this minimum scan threshold 1015 is sustained for a minimum amount of time, the RSSI scan may be initiated in order to detect those locations where RSSI signals are received and not received in order to determine if the reflected EM wave beam needs to be reconfigured at the reconfigurable metasurface unit cell array. In an embodiment, detected motion exceeding the minimum scan threshold 1015 may prompt the RSSI throughput scan to be initiated. In other embodiments, detected motion exceeding the minimum scan threshold 1015 for a minimum amount of scan threshold time period, such as 2 seconds, 10 seconds or any scan threshold time period, may prompt the RSSI throughput scan to be initiated to determine if the current configuration of the reconfigurable metasurface unit cell array remains in a directed state towards a target receiver wireless device or a low throughput zone within the radiofrequency environment by determining if the EM wave beam has been moved away from target receiver wireless device or a low throughput zone within the radiofrequency environment. If moved away, a greater radiofrequency throughput scan may be conducted to determine a new target location within the radiofrequency environment to trigger a reconfiguration of the reconfigurable metasurface unit cell array. The latter process may require greater processing requirements and more power consumption and may require execution of code instructions of the metasurface adaptive wireless beamforming system module, at least in part, by a hardware processor on the information handling system in some embodiments. Executing a radiofrequency throughput scan to determine if the position of the reconfigurable metasurface has moved with a radiofrequency sensor may be conducted by the metasurface controller without waking the information handling system or engaging the hardware processor thereon in some embodiments.

The graph 1000 also includes a reconfiguration threshold 1020. This reconfiguration threshold 1020 may be the normalized acceleration threshold value at which, if sustained for more than a reconfiguration threshold period of time, initiates a reconfiguration of the EM wave beam reflected from the reconfigurable metasurface unit cell array by adjusting one or more unit cells within the reconfigurable metasurface unit cell array as described herein. Any radiofrequency throughput scan for RSSI may be used to determine a location of a target receiver wireless device or a low throughput zone within the radiofrequency environment to redirect the reflected radiofrequency beam from a radiofrequency source device or the information handling system. This includes the hardware controller of a platform control hub of the information handling system executing machine-readable program code of the metasurface adaptive wireless beamforming system module to first determine if the minimum scan threshold 1015 has been reached. The metasurface adaptive wireless beamforming system module, with the platform control hub and the metasurface controller or another radiofrequency sensor or radio device, conducts a radiofrequency throughput scan using plural antennas or plural reconfigurable metasurface unit cells to detect radiofrequency signals or EM waves and determine RSSI values within the radiofrequency environment or the changed orientation of the information handling system and the reconfigurable metasurface. The metasurface adaptive wireless beamforming system module then initiates a hardware controller of the information handling system to determine if the reconfiguration threshold 1020 has been reached for a threshold period of time (e.g., more than 2 seconds or 5 seconds or some other time threshold) to conduct reconfiguration and determination of changed source location of radiofrequency signals and changed target receiver wireless device or low throughput zone locations. The data from the relative RSSI values of plural antennas or plural reconfigurable metasurface unit cells are obtained to reconfigure the reflected EM wave beam towards, for example, a low throughput zone or target receiver wireless device within the radiofrequency environment that the information handling system and its reconfigurable metasurface are located within.

Thus, the graph 1000 shows an example where threshold changes in the movement and detected acceleration of the information handling system may or may not initiate an RSSI radiofrequency throughput scan and may or may not initiate a reconfiguration of the reconfigurable metasurface unit cell array to adjust the directionality of the EM wave beam reflection from a radiofrequency source device, such as an AP or the information handling system itself. Because this process is only initiated when certain conditions have been detected at the information handling system, power at the reconfigurable metasurface unit cell array is saved.

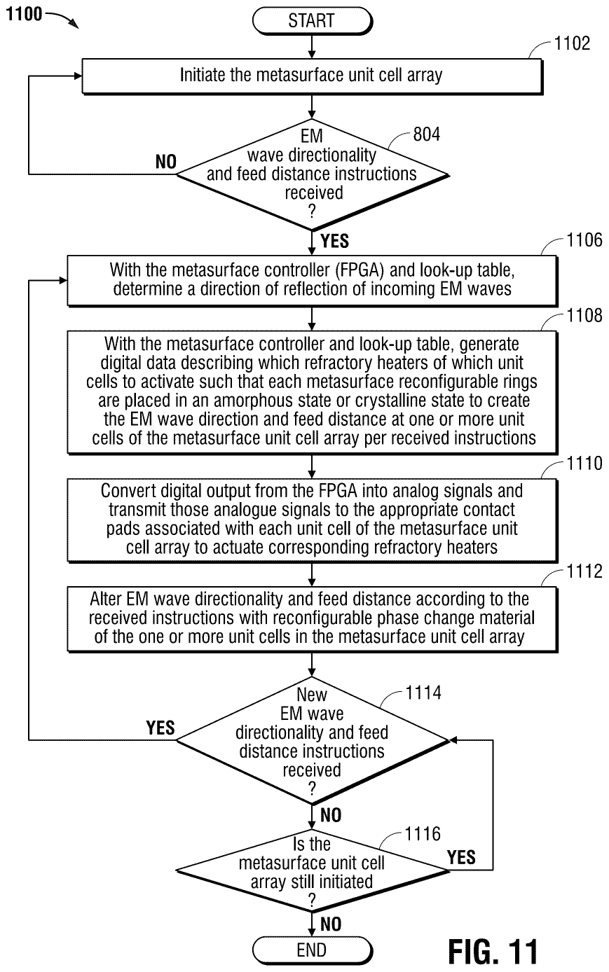

FIG. 11 is a block diagram of a method of controlling a reconfigurable metasurface unit cell array to dynamically change the directionality and feed distance of reflected EM wave beams according to an embodiment of the present disclosure. The reconfigurable metasurface unit cell array used in this method 1100 may be similar to those reconfigurable metasurface unit cell arrays described in connection with, for example, FIGS. 1, 4, 5, and 7. The reconfigurable metasurface unit cell array may include a plurality of reconfigurable metasurface unit cells that are individually controlled using a metasurface PMU or power source, a metasurface controller such as an FPGA, and DAC or other components as described in embodiments herein. It is also contemplated in embodiments herein, that method 1100 may operate with other types of reconfigurable metasurface unit cell arrays operating with reconfigurable metasurface unit cells other than those described in embodiments herein and which may be of a variety of structures and designs including types that may use the elements of phase-changing materials and pulsed heat for toggling conductivity phase changes in those elements according to various other embodiments herein.

At block 1102, the method 1100 may include initiating the reconfigurable metasurface unit cell array. In an embodiment, the reconfigurable metasurface unit cell array may be initiated by a user actuating a power button on the reconfigurable metasurface unit cell array or activating the reconfigurable metasurface unit cell array via a software activation on the information handling system. The metasurface PMU or a power source may then proceed to power a metasurface controller such as an FPGA and DAC in order to receive EM wave directionality and feed distance instructions or to detect from the reconfigurable metasurface unit cell array, or a plurality of antennas, directionality and feed distance of a source wireless device and of a target receiving wireless device or a low radiofrequency throughput zone. In an embodiment, the reconfigurable metasurface unit cell array may be placed on a surface of the information handling system where EM waves may be reflected off from a source wireless device in order to reach a receiving device. In an embodiment, the source wireless device may be the information handling system itself. These surfaces may include an A-cover of an information handling system such as that shown in FIG. 6, a wall, and the side of a building, among other surfaces in a radiofrequency environment where millimeter EM waves of a radiofrequency signal may be relayed around objects that would otherwise prevent penetration.

At block 1104, the method 1100 may include determining whether an EM wave directionality and feed distance instructions have been received or detected between the source wireless device and the target receiving wireless device. In an embodiment, these EM wave directionality and feed distance instructions may be provided via a wireless connection from, for example, a transmitting wireless information handling system or other source wireless computing device that is provided data descriptive of the radiofrequency environment in which the transmitting source wireless computing device and receiving wireless device are located. In embodiments of the present disclosure, the EM wave directionality and feed distance instructions may be triggered from the detection of movement of the information handling system above a reconfiguration threshold of movement levels for more than a reconfiguration threshold duration of time that triggers reconfiguration of the reconfigurable metasurface to detect locations of a radiofrequency signal source wireless device and a target receiver wireless device or a radiofrequency throughput low zone. Based on this determination of source and directionality locations within the radiofrequency environment, execution of machine-readable code instructions of the metasurface adaptive wireless beamforming system module may provide EM wave directionality and feed distance instructions to the metasurface controller of the reconfigurable metasurface unit cell array in embodiments herein.

For example, the radiofrequency environment may include an office building setting where the walls of the individual rooms and offices prevent such short wavelengths from passing through to other wireless devices. In other embodiments, the reconfigurable metasurface unit cells may operate as an array antenna to detect wireless signal directionality from the source wireless computing device and to the target receiving wireless device and provide this to the metasurface controller or other hardware controller to determine wave directionality and feed distance instructions for adjustment. The EM wave directionality and feed distance instructions, in an embodiment, may include location data or direction detected of a receiving wireless device such as a receiving wireless information handling system, an access point, a base station, and the like. Where no EM wave directionality and feed distance instructions have been received, the wireless controller FPGA and DCA do not change any directionality and feed distance characteristics of the reconfigurable metasurface unit cell array and the reconfigurable metasurface unit cell array continues in its current state with the metasurface reconfigurable rings in their current amorphous state or crystalline state.

However, where the EM wave directionality and feed distance instructions have been received, the method 1100 continues to block 1106. At block 1106, the method 1100 further includes determining a direction of reflection of incoming EM waves with the metasurface controller FPGA and a look-up table accessible to the metasurface FPGA. This look-up table may be maintained on a non-volatile memory device associated with which refractory heaters to pulse to change phase change state of the reconfigurable metasurface unit cells to cause particular direction for beamforming of reflected EM waves of the reconfigurable metasurface unit cell array. This look-up table may be accessible to the metasurface controller FPGA in a non-volatile memory thereon so that the FPGA may generate appropriate digital signals such that the directionality and feed distance may be replicated with heat pulses to refractory heaters of particular unit cells at the reconfigurable metasurface unit cell array according to the received EM wave directionality and feed distance instructions.

Thus, at block 1108, the method 1100 also includes generating digital data, as output from the metasurface controller FPGA, describing which contact pads of the refractory heaters of which reconfigurable metasurface unit cells to activate such that each of the metasurface reconfigurable rings are placed in an amorphous state or crystalline state to create the EM wave direction and feed distance beam directionality per the received EM wave directionality and feed distance instructions. As shown in FIGS. 3A and 3B and described herein, each reconfigurable metasurface unit cell of the reconfigurable metasurface unit cell array includes concentrically formed first metasurface reconfigurable split ring, second metasurface reconfigurable split ring, and third metasurface reconfigurable split ring made of any type of phase change materials such as GeTe, SbTe, or GeSbTe among other similar non-volatile phase change materials. In an embodiment, a non-reconfigurable metal fixed ring and non-reconfigurable metal fixed center node made of a metal such as Au, Cu, Al, or Ni among other types of conductive metals may also be placed on the layer formed by the metasurface reconfigurable rings.

In order to maintain the active beam steering capabilities of each of the metasurface reconfigurable split rings a gap in each metasurface reconfigurable split ring may be bridged using a conductive bridge. The conductive bridge allows for induced currents in each of the metasurface reconfigurable split rings when in a conductive crystalline state to create radiated fields that form the reflected wave patterns described herein.

As described herein, the first refractory heater, the second refractory heater, and the third refractory heater are formed under the metasurface reconfigurable rings. The refractory heaters may each, individually and selectively, heat their respective metasurface reconfigurable split ring such that, when a power source is applied to the first refractory heater, the first refractory heater pulse heats the first metasurface reconfigurable split ring, the second refractory heater pulse heats the second metasurface reconfigurable split ring, and third refractory heater 268-3, the third refractory heater pulse heats the third metasurface reconfigurable split ring. Thus, the states of each of the metasurface reconfigurable split rings may be individual controlled via pulse heating of the individual refractory heaters such that the states of the metasurface reconfigurable split rings may be switched from their amorphous states to their crystalline states or vice versa based on the EM wave directionality and feed distance instructions.

At block 1110, the method 1100, therefore, includes converting digital output from the metasurface controller FPGA into analog signal and power via the DAC and a power source and transmitting those analogue signals and power to the appropriate contact pads associated with each reconfigurable metasurface unit cell of the reconfigurable metasurface unit cell array. Again, the applied voltage and current to each of the refractory heaters generates a heat pulse to change the state of the non-volatile phase change material of each metasurface reconfigurable split ring. The amplitude and duration of an applied heat pulse to switch states may depend on the type of non-volatile phase change material used and the present specification contemplates that a plurality of non-volatile phase change materials may be used necessitating changes in these applied voltages and currents depending on the phase change material used.

At block 1112, as a result of the electrical signals and power to the contact pads from the DAC, the EM wave directionality and feed distance are altered accordingly to the originally received EM wave directionality and feed distance instructions. Again, the metasurface reconfigurable rings may be used to invoke constructive and/or destructive interference in the reconfigurable metasurface unit cells in directions such that a beam lobe is created that is directed towards or focused towards a receiving wireless device.

At block 1114, the method 1100 continues by detecting whether a new set of EM wave directionality and feed distance instructions have been received or detected at the metasurface controller FPGA. Where a new set of EM wave directionality and feed distance instructions have been received or detected from a source wireless device, the method 1100 continues to block 1106 with the metasurface controller FPGA executing those processes described herein. Where no new EM wave directionality and feed distance instructions have been received, the method 1100 continues to block 1116.

At block 1116, the method 1100 includes determining if the reconfigurable metasurface unit cell array is still initiated. Where the reconfigurable metasurface unit cell array is still initiated, the method 1100 proceeds to block 1114 with the FPGA monitoring to determine if new EM wave directionality and feed distance instructions have been received as described herein. Where the reconfigurable metasurface unit cell array is no longer initiated, the method 1100 may end here.

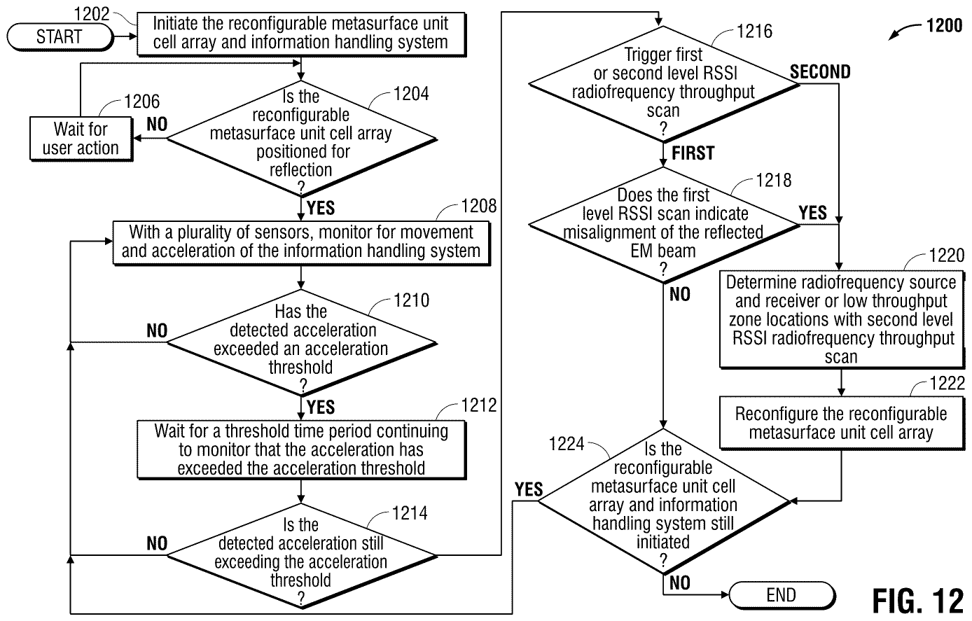

FIG. 12 is a block diagram of a method 1200 of maximizing throughput in an environment with a reconfigurable metasurface unit cell array according to an embodiment of the present disclosure. The method 1200 may be conducted using the information handling system such as the information handling system described in connection with any of FIGS. 1, 2, 7, and 9 as well as the reconfigurable metasurface unit cell array described in connection with any of FIGS. 1-9. The reconfigurable metasurface unit cell array may include a plurality of reconfigurable metasurface unit cells that are individually controlled using a metasurface PMU or power source, a metasurface controller such as an FPGA, and DAC or other components as described in embodiments herein. It is also contemplated in embodiments herein, that method 1200 may operate with other types of reconfigurable metasurface unit cell arrays operating with reconfigurable metasurface unit cells other than those described in embodiments herein and which may be of a variety of structures and designs including types that may use the elements of phase-changing materials and pulsed heat for toggling conductivity phase changes in those elements according to various other embodiments herein.

At block 1202, the method 1200 may include initiating the information handling system with the reconfigurable metasurface unit cell array or the reconfigurable metasurface unit cell array while the information handling system is in a sleep mode but the display chassis is opened. As described herein, the information handling system and reconfigurable metasurface unit cell array may be operatively coupled together via a wired or wireless connection. In some embodiments, the reconfigurable metasurface unit cell array may be initiated by a switch or action of opening a display of the information handling system. In other embodiments, software control on the operatively coupled information handling system may be used to initiate the reconfigurable metasurface unit cell array. In an example embodiment where the information handling system is operatively coupled to the reconfigurable metasurface unit cell array, a metasurface controller of the reconfigurable metasurface unit cell array may monitor for a wake signal or other signal indicating that the information handling system has been initiated. In other embodiments, the metasurface controller of the reconfigurable metasurface unit cell array may monitor for movement of the information handling system in sleep mode with a hardware controller of a platform control hub monitoring for a minimum scan threshold or a reconfiguration threshold. Upon determination that reconfiguration of the reconfigurable metasurface unit cell array is required, the metasurface controller may wake the information handling system in some embodiments, or if enough processing power is provided with the metasurface controller or platform control hub controller may conduct a reconfiguration radiofrequency throughput scan to determine locations and readjust the directionality of beamforming reflection of the reconfigurable metasurface unit cell array.

Where the information handling system is operatively coupled to the reconfigurable metasurface unit cell array via a wired connection, the initiation of the information handling system may cause power to be provided to the reconfigurable metasurface unit cell array causing the reconfigurable metasurface unit cell array to be initiated as well. In other embodiments, the reconfigurable metasurface unit cell array may be powered by a separate, independent power source. Thus, it is appreciated that in some example embodiments, the reconfigurable metasurface unit cell array may be powered by its own PMU (e.g., metasurface PMU) or may be powered by the PMU of the information handling system.

As described below, the reconfigurable metasurface unit cell array may then initiate the reconfigurable metasurface unit cells within the reconfigurable metasurface unit cell array to create an EM wave beam in direction as described in instructions determined via execution of the metasurface adaptive wireless beamforming system module for locations of source and receiver wireless devices or low radiofrequency throughput zones within the radiofrequency environment. In an embodiment, RSSI data from plural receiving antennas or unit cells of the information handling system or the reconfigurable metasurface unit cell array may be used to conduct the radiofrequency throughput scan for locations of radiofrequency source devices and receiver wireless devices or low radiofrequency throughput zones relative to the reconfigurable metasurface unit cell array within the radiofrequency environment. With this location data of the radiofrequency environment, unit cells of the reconfigurable metasurface unit cell array may be adjusted to direct the EM wave beam towards another receiver wireless device or information handling system or a low throughput zone within the radiofrequency environment.

At block 1204, the method 1200 also includes determining if the reconfigurable metasurface unit cell array is positioned with the information handling system and initiated such that reflection of radiofrequency signals in the radiofrequency environment is available. In an example embodiment, this may include determining whether the lid or display chassis of the information handling system, such as a laptop information handling system, is in an open state. the user has logged in. A hall sensor or other sensor may determine the position of the lid or display chassis. In another embodiment, determining if the reconfigurable metasurface unit cell array is positioned may include determination of whether a table or handheld information handling system is oriented such that the reconfigurable metasurface unit cell array is positioned for reflection of radiofrequency signals, such as in a stand. Further, execution of metasurface context aware and configuration software applications operating with the metasurface adaptive wireless beamforming system module may determine if the reconfigurable metasurface unit cell array is positioned from a hall sensor, proximity sensor, gyroscope, or accelerometer and may further determine if a user is logged in to an operatively coupled information handling system in some embodiments.

In one example embodiment, operation of a hall sensor that may determine the orientation of the information handling system such as the relative position of the lid or display chassis to the base portion of the information handling system. Additionally, data associated with the operating system (OS) of the information handling system may be provided to determine if the user has logged into the information handling system. Where the lid of the information handling system is not open and/or the user is not logged into the information handling system, the reconfigurable metasurface unit cell array may not benefit from initiating any reconfiguration of the any unit cells within the reconfigurable metasurface unit cell array or otherwise monitor for changes in movement and acceleration of the information handling system.

Where the lid or display chassis of the information handling system is not opened or another information handling system is not positioned for reflection and the user is not logged into the information handling system at block 1204, the method 1200 may continue to block 1206 to wait for user action such as the user opening the lid of display chassis and logging into the information handling system. Where, however, the sensors have detected that the lid or display chassis of the information handling system has been opened and the user has logged into the information handling system, the method 1200 proceeds to block 1208.

At block 1208, the method 1200 further includes monitoring for movement and acceleration of the information handling system. As described herein, this may be accomplished via operation of a plurality of different sensors by the hardware processor of the information handling system. These sensors may include a proximity sensor, a hall sensor, a gyroscope, an accelerometer, an RF radio sensor, a GPS sensor or a combination thereof. As described herein, data from each of these sensors may be accumulated at a platform control hub and a sensing hub module executed by a platform control hub controller if an information handling system is in a sleep mode or by the hardware processor of the information handling system. This allows all of this data to be addressed and used to determine the movement, acceleration, and placement of the information handling system and, accordingly, determine either a minimum scan threshold level and duration of movement or a reconfiguration threshold of movement and duration do determine if the reconfigurable metasurface unit cell array affixed or coupled to the information handling system requires reconfiguration of unit cells to redirect EM wave beamforming of reflected radiofrequency signals. For purposes of description, the present embodiment describes detection of acceleration with an accelerometer and/or gyroscope of the information handling system and its operatively coupled reconfigurable metasurface unit cell array for movement levels.

At block 1210, the method 1200 also includes determining if detected acceleration has exceeded an acceleration threshold in an embodiment. It is appreciated that as the user uses the information handling system plural sensors, including the accelerometer, gyroscope, and others, may detect movement and acceleration of the information handling system even if the user is simply typing on the keyboard. Thus, one or more acceleration thresholds may be established such that typing on the keyboard of the information handling system does not initiate a power consuming RSSI radiofrequency throughput scan process or unnecessary reconfiguration of the reconfigurable metasurface unit cell array process as described herein. Example acceleration thresholds have been described in connection with FIG. 10 and may include an idle threshold, a minimum scan threshold, and a reconfiguration threshold. Again, the idle threshold may be set to a specific level of detectable and normalized acceleration (e.g., movement and change of velocity of information handling system over time) such that, so long as plotted movement points do not exceed a positive or negative rate of change of velocity over time motion is not assessed and not radiofrequency throughput scan is initiated for the reconfigurable metasurface unit cell array.

The minimum scan threshold may be the normalized acceleration threshold value at which an RSSI scan is initiated with an radiofrequency sensor to determine if RSSI values from varying locations at the reconfigurable metasurface unit cell array has changed such that reconfiguration may be required. The metasurface adaptive wireless beamforming system module may then determine if the minimum scan threshold level of movement or acceleration has been reached for a scan threshold period of time (e.g., more than 2 seconds, more than 5 seconds, or another duration). The radiofrequency sensor may operate with at least one antenna positioned with the reconfigurable metasurface unit cell array or with at least one reconfigurable metasurface unit cell and the metasurface controller to determine if RSSI level change threshold has occurred. If change in the RSSI values has exceeded an RSSI change value, then a more extensive radiofrequency throughput scan of the radiofrequency environment may be conducted by the metasurface adaptive wireless beamforming system module to determine locations of a radiofrequency source device and a target receiver wireless device or a radiofrequency low-throughput zone in the radiofrequency environment for generating EM wave directionality and feed distance instructions to the metasurface controller for readjustment of a reflected radiofrequency beam. In an embodiment, if this minimum scan threshold is sustained for a minimum amount of time, the RSSI scan may be initiated plural antennas positioned with the reconfigurable metasurface unit cell array or with plural reconfigurable metasurface unit cells in order to detect those locations where RSSI signals are received and not received in the radiofrequency environment in order to determine if the reflected EM wave beam needs to be reconfigured at the reconfigurable metasurface unit cell array.

In another embodiment, a reconfiguration threshold level of movement and duration may be the normalized acceleration threshold value at which, if sustained for more than a reconfiguration threshold period of time, initiates a reconfiguration of the EM wave beam reflected from the reconfigurable metasurface unit cell array by conducting the more extensive radiofrequency throughput scan of the radiofrequency environment may be conducted by the metasurface adaptive wireless beamforming system module to determine locations of a radiofrequency source device and a target receiver wireless device or a radiofrequency low-throughput zone in the radiofrequency environment for generating EM wave directionality and feed distance instructions to the metasurface controller for adjusting one or more unit cells within the reconfigurable metasurface unit cell array as described herein. At the reconfiguration threshold level of movement and duration, an initial radiofrequency throughput scan may be skipped due to a greater level of detected movement of the information handling system and reconfigurable metasurface unit cell array. This may include the hardware processor of the information handling system executing machine-readable program code of the metasurface adaptive wireless beamforming system module to first determine if the minimum scan threshold level of motion and duration has been reached or if the reconfiguration threshold level of motion and duration has been reached. The metasurface adaptive wireless beamforming system module may then initiate an appropriate radiofrequency throughput scan level to determine whether RSSI values have changed within the environment or to determine radiofrequency source device location and target receiver wireless device or low radiofrequency throughput zone locations in the radiofrequency environment. The metasurface adaptive wireless beamforming system module may then determine if the reconfiguration threshold level of movement or acceleration has been reached for a reconfiguration threshold period of time (e.g., more than 2 seconds, more than 5 seconds, or another duration).

Where none of these acceleration thresholds have been reached or where only the idle threshold has been detected as being reached, the method 1200 continues back to block 1208 for the metasurface adaptive wireless beamforming system module executed by the hardware processor of the information handling system monitoring for movement and acceleration of the information handling system.

Where, however, at block 1210, one of the minimum scan threshold and/or reconfiguration threshold have been reached or exceeded, the method 1200 continues to block 1212. At block 1212, the hardware processor may wait for a threshold time period by continuing to monitor that the acceleration has exceeded the one or more acceleration threshold. In an embodiment, this threshold time period may be 2 seconds or 5 seconds.

At block 1214, the method 1200 includes determining if the acceleration detected by the execution of the machine-readable program code of the metasurface adaptive wireless beamforming system module still exceeding the acceleration threshold, for example either the minimum scan threshold level of acceleration or the reconfiguration threshold level of acceleration. Where the acceleration is no longer exceeding the acceleration threshold level before the threshold duration (e.g., stopped within 2 seconds or 5 seconds), the method 1200 may continue back to block 1208 for processing as described herein. It is appreciated that the user may slightly move the information handling system to adjust for comfort or some other reason and this may not drastically affect the positioning of the information handling system and the reflection of the EM wave beam from the surface of the reconfigurable metasurface unit cell array. Thus, throughput radiofrequency scans or reconfiguration of the reconfigurable metasurface unit cells of the reconfigurable metasurface unit cell array and resulting EM wave beam emissions may not be necessary.

Where, however, the detected acceleration has exceeded the acceleration threshold for the threshold time period, the method continues to block 1216. At block 1216, the method 1200 includes triggering an RSSI radiofrequency throughput scan. As described, two levels of RSSI radiofrequency throughput scans may be triggered at block 1216. For when the minimum scan threshold level of acceleration has been exceeded for a scan threshold duration, a minimum radiofrequency throughput scan may be initiated at lower power to determine if RSSI levels have changed and flow proceeds to block 1218. This minimum radiofrequency throughput scan may be conducted using low power and processing via one or more antennas or reconfigurable metasurface unit cells, a radiofrequency sensor and the metasurface controller without resources of the information handling system being used to determine if reflected radiofrequency signal directionality has indeed changed. If it has, then flow proceeds to block 1220 for the second level of reconfiguration radiofrequency throughput scan for identifying locations of radiofrequency source device and target receiver wireless devices or a low radiofrequency throughput zone may be conducted. Alternatively, if the reconfiguration threshold level of acceleration has been exceeded for a reconfiguration threshold duration at block 1216, then flow proceeds to block 1220 from block 1216 and the second level of reconfiguration radiofrequency throughput scan is initiated to identify locations of radiofrequency source device and target receiver wireless devices or a low radiofrequency throughput zone may be conducted. This second level reconfiguration RSSI radiofrequency throughput scan may include utilization of plural antennas co-located relative to the reconfigurable metasurface unit cell array or plural reconfigurable metasurface unit cells with any process in which the information handling system measures the strength of radio signals received from wireless transmitters or locations within the environment where such radio signal are not received to determine directionality of those location. Those locations within the radiofrequency environment where RSSI signals are not received may indicate a low radiofrequency throughput zone within the environment and may be used later to redirect the EM wave beam towards that area.

Returning to block 1218, the method 1200 also includes determining if the RSSI scan indicate misalignment of the reflected EM beam towards a low radiofrequency throughput zone or target receiver wireless device location within the radiofrequency environment the information handling system is present within. It can be appreciated that the RSSI data from, for example, the RF radio sensor, based on plural antennas or plural reconfigurable metasurface unit cells detecting radiofrequency signals in the radiofrequency environment, may indicate that the current configuration, orientation, and alignment of the reflected EM wave beam from off of the reconfigurable metasurface unit cell array may not be properly directed. For example, the EM wave beam may no longer be directed towards a low throughput zone location or a target receiver wireless device within radiofrequency environment due to the movement of the information handling system by the user. If, at block 1218, it is determined that the EM wave beam is misaligned, the method 1200 continues to block 1220.

As described, at block 1220, the second level of reconfiguration radiofrequency throughput scan is initiated to identify locations of radiofrequency source device and target receiver wireless devices or a low radiofrequency throughput zone may be conducted. This second level reconfiguration RSSI radiofrequency throughput scan may include utilization of plural antennas co-located relative to the reconfigurable metasurface unit cell array or plural reconfigurable metasurface unit cells to measure the strength of radio signals received from wireless transmitters or locations within the environment where such radio signal are not received to determine directionality of those location. Differences in RSSI levels between plural antennas co-located at the reconfigurable metasurface unit cell array on the information handling system or plural reconfigurable metasurface unit cells in the reconfigurable metasurface unit cell array of known spacing may be used to determine a radiofrequency source information handling system as well as a target receiver wireless device such as a target information handling system or a low radiofrequency throughput zone with low RSSI levels in the radiofrequency environment in embodiments herein. Those locations identified within the radiofrequency environment where RSSI signals are not received may indicate a low radiofrequency throughput zone within the environment and may be used later to redirect the EM wave beam towards that area. Such determination of locations within the radiofrequency environment of the reconfigurable metasurface unit cell array may require greater power consumption and processing resources for execution of machine-readable code instructions of the metasurface adaptive wireless beamforming system module than a first level RSSI radiofrequency throughput scan by an RF sensor to determine if RSSI change has occurred in the orientation of the reconfigurable metasurface unit cell array.

At block 1222, the EM wave reflection properties of the reconfigurable metasurface unit cell array may be reconfigured. The hardware processor of the information handling system, a hardware controller of the platform control hub, or the metasurface controller may execute machine readable code instructions of the metasurface adaptive wireless beamforming system module to generate EM wave directionality and feed distance instructions for locations of a radiofrequency source device and a target receiver wireless device or low radiofrequency throughput zone in the radiofrequency environment for the reconfigurable metasurface unit cell array. The reconfiguration process adjusts beamforming directionality of one or more reconfigurable metasurface unit cells of the reconfigurable metasurface unit cell array may include those processes described herein. For example, the metasurface controller adjusts conductivity of phase-shifting elements of one or more reconfigurable metasurface unit cells, such as specifically described in connection with FIG. 11, based on the EM wave directionality and feed distance instructions generated by the metasurface adaptive wireless beamforming system module determined from the second level RSSI radiofrequency throughput scan as described.

Where the RSSI data obtained at block 1216 and evaluated at block 1218 indicates that the EM wave beam is not misaligned, then the method 1200 continues to block 1224. Where the reconfiguration of the reconfigurable metasurface unit cell array has been completed at block 1222, the method 1200 continues to block 1224. At block 1224, the method 1200 includes determining if the reconfigurable metasurface unit cell array or the information handling system are still initiated. Where the reconfigurable metasurface unit cell array and information handling system are still initiated or whether the lid of the information handling system is still open, the method 1200 proceeds to block 1208 with the information handling system continuing to monitor for movement and acceleration of the information handling system as described herein. Where the reconfigurable metasurface unit cell array and information handling system are no longer initiated or the lid of the information handling system has been closed, the method 1200 may end here.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processor, a memory device, and a power management unit (PMU) to provide power to the hardware processor and memory device;
a reconfigurable metasurface unit cell array operatively coupled to the information handling system to directionally reflect an electromagnetic wave (EM) of a radiofrequency signal, the reconfigurable metasurface unit cell array including a plurality of reconfigurable metasurface unit cells, each of the plurality of reconfigurable metasurface unit cells including a center conductive node and an outer conductive ring and a first metasurface reconfigurable split ring and a second metasurface reconfigurable split ring of a phase-changing material;
each reconfigurable metasurface unit cell to selectively switch between a conductive state of the phase-changing material and a dielectric state of the phase-changing material of the first metasurface reconfigurable split ring and the second metasurface reconfigurable split ring via a heat pulse controlled by a metasurface controller from a first refractory heater and a second refractory heater corresponding to the first metasurface reconfigurable split ring and the second metasurface reconfigurable split ring respectively;
machine-readable code instructions of a metasurface adaptive wireless beamforming system module to, when executed by the hardware processor or a platform controller hub (PCH) hardware controller, detect movement of the information handling system via a motion sensor to determine if the movement of the information handling system exceeds a movement threshold; and
the metasurface controller to reconfigure the electromagnetic reflective properties of the reconfigurable metasurface unit cell array to reconfigure the reflected EM wave direction towards a low radiofrequency throughput zone within a radiofrequency environment of the reconfigurable metasurface unit cell array.

2. The information handling system of claim 1 further comprising:
each reconfigurable metasurface unit cell including a plurality of contact pads to operatively couple the first refractory heater and the second refractory heater to a metasurface power source controlled by the metasurface controller to provide power to the first refractory heater and the second refractory heater for the heat pulse.

3. The information handling system of claim 1 wherein the reconfigurable metasurface unit cell array is formed on an outer surface of an display chassis cover of the information handling system.

4. The information handling system of claim 1 further comprising:
a plurality of sensors to detect the movement of the information handling system and the PCH hardware controller to receive output from those plurality of sensors, determine that the movement of the information handling system has exceeded the movement threshold; and
the machine-readable code instructions of the metasurface adaptive wireless beamforming system module to execute a received signal strength indicator (RSSI) radiofrequency throughput scan and use resulting RSSI data from a radio frequency sensor to determine a location of the low radiofrequency throughput zone relative to the reconfigurable metasurface unit cell array within the radiofrequency environment of the information handling system.

5. The information handling system of claim 1 wherein the phase-changing material of each of the first metasurface reconfigurable split ring and the second metasurface reconfigurable split ring is selected from germanium telluride (GeTe), antimony telluride (SbTe), or chalcogenide (GeSbTe) that selectively switch between the conductive state and the dielectric state when heat is applied.

6. The information handling system of claim 1 wherein the motion sensor is an accelerometer and a detected movement measurement is a normalized acceleration value.

7. The information handling system of claim 1 further comprising:
the machine-readable code instructions of the metasurface adaptive wireless beamforming system module to detect the movement of the information handling system via the motion sensor to determine if the movement of the information handling system exceeds the movement threshold that is a minimum scan movement threshold exceeding a first scan threshold period of time; and
the machine-readable code instructions of the metasurface adaptive wireless beamforming system module initiating an RSSI radiofrequency throughput scan with a radiofrequency sensor to determine when the reflected EM wave direction has been changed by the movement of the information handling system before metasurface controller reconfigures the electromagnetic reflective properties of the reconfigurable metasurface unit cell array.

8. The information handling system of claim 1 further comprising:
the machine-readable code instructions of the metasurface adaptive wireless beamforming system module to detect the movement of the information handling system via the motion sensor to determine when the movement of the information handling system exceeds the movement threshold that is a reconfiguration movement threshold exceeding a reconfiguration threshold period of time; and
the machine-readable code instructions of the metasurface adaptive wireless beamforming system module initiating an RSSI radiofrequency throughput scan with a radiofrequency sensor to determine locations of a radiofrequency source device and a low radiofrequency throughput zone within the radiofrequency environment of the reconfigurable metasurface unit cell array before the metasurface controller reconfigures the electromagnetic reflective properties of the reconfigurable metasurface unit cell array.

9. A method of maximizing radiofrequency signal throughput in a radiofrequency environment with a reconfigurable metasurface unit cell array operatively coupled to an information handling system comprising:
executing machine-readable program code instructions of a metasurface adaptive wireless beamforming system module with a hardware processor to monitor movement of the information handling system via a motion sensor;
executing machine-readable program code instructions of the metasurface adaptive wireless beamforming system module with the hardware processor to determine when detected movement of the information handling system exceeds a movement threshold;
initiating a received signal strength indicator (RSSI) radiofrequency throughput scan and use resulting RSSI data to determine a location of a radiofrequency source device and a target receiver wireless device or a low radiofrequency throughput zone relative to the reconfigurable metasurface unit cell array within the radiofrequency environment of the information handling system; and
reconfiguring, with a metasurface hardware controller, the electromagnetic reflective properties of one or more reconfigurable metasurface unit cells of the reconfigurable metasurface unit cell array to reflect EM wave towards the location of the target receiver wireless device or the low throughput zone within the radiofrequency environment, where the metasurface hardware controller switches between a conductive state and a dielectric state of an element of the one or more reconfigurable metasurface unit cells.

10. The method of claim 9, wherein the reconfigurable metasurface unit cell array formed on an outer surface of an display chassis cover of the information handling system.

11. The method of claim 9 further comprising:
receiving the location of the target receiver wireless device or the low radiofrequency throughput zone relative to the reconfigurable metasurface unit cell array within the radiofrequency environment of the information handling system; and
pulsing heat to at least one refractory heater to selectively heat the element of the one or more reconfigurable metasurface unit cells to switch between the conductive state and the dielectric state to reconfigure the electromagnetic reflective properties of the one or more reconfigurable metasurface unit cells, wherein the element of the one or more reconfigurable metasurface unit cells is comprised of an non-volatile phase-changing material.

12. The method of claim 9, wherein the element of the one or more reconfigurable metasurface unit cells is made of a phase-changing material selected from germanium telluride (GeTe), antimony telluride (SbTe), or chalcogenide (GeSbTe) that selectively switch between the conductive state in a crystalline form and the dielectric state in an amorphous form when heat is applied.

13. The method of claim 9 further comprising:
with a plurality of sensors, detecting the movement of the information handling system and providing output from the plurality of sensors to a platform controller hub (PCH) at the information handling system to determine that the movement of the information handling system has exceeded the movement threshold.

14. The method of claim 10 further comprising:
with a system configuration sensor, detecting a configuration of the information handling system that the display chassis cover of the information handling system is open, where the information handling system is a laptop-type information handling system; and
initiating monitoring of movement of the information handling system relative to the movement threshold for automatic reconfiguration of the reflected EM wave of the reconfigurable metasurface unit cell array on display chassis cover of the information handling system.

15. An information handling system comprising:
a hardware processor, a memory device, and a power management unit (PMU) to provide power to the hardware processor and memory device;
a reconfigurable metasurface unit cell array operatively coupled to the information handling system to directionally reflect an electromagnetic wave (EM) of a radiofrequency signal, the reconfigurable metasurface unit cell array including a plurality of reconfigurable metasurface unit cells, each of the plurality of reconfigurable metasurface unit cells includes a switchable element between a conductive state and a dielectric state in the reconfigurable metasurface unit cells, where the switchable element is comprised of a non-volatile phase-changing material;
machine-readable code instructions of a metasurface adaptive wireless beamforming system module to, when executed by the hardware processor or a platform controller hub (PCH) hardware controller, detect movement of the information handling system via a motion sensor to determine if the movement of the information handling system exceeds a movement threshold; and
a metasurface controller to reconfigure the electromagnetic reflective properties of the reconfigurable metasurface unit cell array by switching the switchable element of at least one reconfigurable metasurface unit cell between the conductive state and the dielectric state to reconfigure the reflected EM wave direction towards a target receiver wireless device or a low radiofrequency throughput zone within a radiofrequency environment of the reconfigurable metasurface unit cell array.

16. The information handling system of claim 15 further comprising:
a plurality of sensors to detect the movement of the information handling system and the PCH to receive output from those plurality of sensors to determine that the movement of the information handling system has exceeded the movement threshold; and
the machine-readable code instructions of the metasurface adaptive wireless beamforming system module to use received signal strength indicator (RSSI) data from a RSSI radiofrequency throughput scan to determine a location of a radiofrequency source device and the target receiver wireless device or the low throughput zone within the radiofrequency environment relative to the reconfigurable metasurface unit cell array of the information handling system for the metasurface controller to reconfigure the electromagnetic reflective properties of the reconfigurable metasurface unit cell array.

17. The information handling system of claim 15 wherein the non-volatile phase-changing material is selected from germanium telluride (GeTe), antimony telluride (SbTe), or chalcogenide (GeSbTe) that selectively switch between the conductive state in a crystalline state and the dielectric state in an amorphous state when heat is applied.

18. The information handling system of claim 15 further comprising:
each reconfigurable metasurface unit cell of the reconfigurable metasurface unit cell array includes a center conductive node, an outer conductive ring, and the switchable element includes a first metasurface reconfigurable split ring and a second metasurface reconfigurable split ring comprised of the phase-changing material; and
each reconfigurable metasurface unit cell to selectively switch between the conductive state of the phase-changing material and the dielectric state of the phase-changing material of the first metasurface reconfigurable split ring and the second metasurface reconfigurable split ring via a heat pulse controlled by the metasurface controller from a first refractory heater and a second refractory heater corresponding to the first metasurface reconfigurable split ring and the second metasurface reconfigurable split ring respectively;

19. The information handling system of claim 15 further comprising:
the machine-readable code instructions of the metasurface adaptive wireless beamforming system module to detect the movement of the information handling system via the motion sensor to determine if the movement of the information handling system exceeds the movement threshold that is a minimum scan movement threshold exceeding a first scan threshold period of time; and
the machine-readable code instructions of the metasurface adaptive wireless beamforming system module initiating an RSSI radiofrequency throughput scan with a radiofrequency sensor to determine when the reflected EM wave direction has been changed by the movement of the information handling system before metasurface controller reconfigures the electromagnetic reflective properties of the reconfigurable metasurface unit cell array.

20. The information handling system of claim 15 further comprising:
the machine-readable code instructions of the metasurface adaptive wireless beamforming system module to detect the movement of the information handling system via the motion sensor to determine when the movement of the information handling system exceeds the movement threshold that is a reconfiguration movement threshold exceeding a reconfiguration threshold period of time; and
the machine-readable code instructions of the metasurface adaptive wireless beamforming system module initiating an RSSI radiofrequency throughput scan with a radiofrequency sensor to determine locations of a radiofrequency source device and the target receiver wireless device or the low radiofrequency throughput zone within the radiofrequency environment of the reconfigurable metasurface unit cell array before the metasurface controller reconfigures the electromagnetic reflective properties of the reconfigurable metasurface unit cell array.
